(19) United States
(12) Patent Application Publication
(10) Pub. No.: US 2026/0204471 A1
(43) Pub. Date: Jul. 16, 2026

(54) INDUCTOR COMPONENT, METHOD OF MANUFACTURING INDUCTOR COMPONENT, AND SUBSTRATE FOR MANUFACTURING INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Keisuke KUNIMORI, Nagaokakyo-shi (JP)

(73) Assignee: Murata Manufacturing Co., Ltd., Kyoto-fu (JP)

(21) Appl. No.: 19/565,138

(22) Filed: Mar. 12, 2026

Related U.S. Application Data
(63) Continuation of application No. PCT/JP2024/015347, filed on Apr. 18, 2024.

(30) Foreign Application Priority Data
Sep. 20, 2023 (JP) 2023-152734

(51) Int. Cl. H01F 27/28; H01F 27/32; H01F 41/04; H01F 41/12

(52) U.S. Cl. CPC H01F 27/2804; H01F 27/2871; H01F 27/323; H01F 41/042; H01F 41/046; H01F 41/122; H01F 2027/2809

(57) ABSTRACT

An inductor component includes an element body, a first insulating layer, and lower and upper inductor wiring lines. The lower inductor wiring line includes a lower wiring main portion and a lower protruding portion protruding from an outer surface of the lower wiring main portion on a third negative direction side. The outer surface of the lower wiring main portion on the third negative direction side contacts an outer surface of the first insulating layer on a third positive direction side. In a transparent view in the third positive direction, the lower protruding portion is within a region surrounded by an outer edge of the lower wiring main portion and extends along the lower wiring main portion. An outer surface of the upper inductor wiring line on the third negative direction side contacts a surface of the lower inductor wiring line on the third positive direction side.

### CROSS-REFERENCE TO RELATED APPLICATIONS

This application claims benefit of priority to International Patent Application No. PCT/JP 2024/015347, filed Apr. 18, 2024, and to Japanese Patent Application No. 2023-152734, filed Sep. 20, 2023, the entire contents of each are incorporated herein by reference.

### BACKGROUND

### Technical Field

The present disclosure relates to an inductor component, a method of manufacturing an inductor component, and a substrate for manufacturing an inductor component.

### Background Art:

The inductor component disclosed in Japanese Patent No. 6447368 includes an element body and an inductor wiring line. The element body has a first main surface. The inductor wiring line extends parallel to the first main surface in the element body. The inductor wiring line has a spiral shape. In other words, the inductor wiring line has portions extending in parallel.

### SUMMARY

In inductor components as disclosed in Japanese Patent No. 6447368, there are cases where the cross-sectional area of the inductor wiring line is increased to reduce the DC resistance of the inductor wiring line. However, for example, in the case where the width dimension of the inductor wiring line is increased, the distance between the portions of the inductor wiring line extending in parallel decreases. This increases the possibility of a short circuit, for example, between the portions of the inductor wiring line extending in parallel when manufacturing deviations or the like occur.

Accordingly, an aspect of the present disclosure provides an inductor component including: an element body containing a magnetic material and having a planar main surface; an insulating layer located in the element body and extending along a plane parallel to the main surface; a lower inductor wiring line extending parallel to the main surface in the element body; and an upper inductor wiring line extending parallel to the main surface in the element body. When one direction orthogonal to the main surface is defined as a positive direction, and the direction opposite to the positive direction is defined as a negative direction, the lower inductor wiring line includes a lower wiring main portion extending on an outer surface of the insulating layer on the positive direction side, and a protruding portion protruding in the negative direction from an outer surface of the lower wiring main portion on the negative direction side. The outer surface of the lower wiring main portion on the negative direction side is in contact with the outer surface of the insulating layer on the positive direction side. In a transparent view in the positive direction, the protruding portion is located within a region surrounded by an outer edge of the wiring main portion and extends along the wiring main portion. In a cross-sectional view taken along a cross section orthogonal to the main surface, the dimension of the protruding portion in the direction parallel to the main surface is smaller than the dimension of the wiring main portion in the direction parallel to the main surface at the position where the protruding portion is connected in the same cross section. The upper inductor wiring line extends along the lower wiring main portion on an outer surface of the lower wiring main portion on the positive direction side, and an outer surface of the upper inductor wiring line on the negative direction side is in contact with a surface of the lower inductor wiring line on the positive direction side.

An aspect of the present disclosure is a method of manufacturing an inductor component including a seed layer forming step of forming a seed layer having conductivity on a main surface of a base substrate; an insulating layer forming step of forming an insulating layer on the seed layer, the insulating layer having an opening corresponding to a specified wiring pattern; a lower resin wall forming step of forming a lower resin wall along an outer edge of the opening on the insulating layer; and a lower inductor wiring line forming step of forming a lower wiring main portion in a space surrounded by the lower resin wall by electrolytic plating by supplying electric current to the seed layer, and forming a protruding portion in the opening, the lower protruding portion protruding from the lower wiring main portion and extending along the lower wiring main portion. The method further includes an upper resin wall forming step of forming an upper resin wall along an outer edge of the lower wiring main portion on an upper side of the lower wiring main portion; an upper inductor wiring line forming step of forming an upper inductor wiring line in a space surrounded by the upper resin wall by electrolytic plating by supplying electric current to the seed layer; an element body forming step of forming a magnetic layer containing a magnetic material around the lower wiring main portion, the lower protruding portion, and the upper inductor wiring line after the upper inductor wiring line forming step; and a seed layer removing step of removing the seed layer after the first element body forming step.

An aspect of the present disclosure is a substrate for manufacturing an inductor component including a base substrate; a seed layer located on a main surface side of the base substrate and having conductivity; an insulating layer located on the seed layer and extending parallel to the main surface of the base substrate; a lower inductor wiring line located on the insulating layer and extending parallel to the main surface of the base substrate; and an upper inductor wiring line located on the lower inductor wiring line and extending parallel to the main surface of the base substrate. When one direction orthogonal to the main surface of the base substrate is defined as a positive direction, and the direction opposite to the positive direction is defined as a negative direction, the lower inductor wiring line includes a lower wiring main portion extending on an outer surface of the insulating layer on the positive direction side, and a protruding portion protruding in the negative direction from an outer surface of the lower wiring main portion on the negative direction side. In a transparent view in the positive direction, the protruding portion extends along the lower wiring main portion. A surface of the protruding portion on the negative direction side is in contact with the seed layer, the upper inductor wiring line extends along the lower wiring main portion on an outer surface of the lower wiring main portion on the positive direction side, and a surface of the upper inductor wiring line on the negative direction side is in contact with a surface of the lower inductor wiring line on the positive direction side.

It is possible to reduce the DC resistance of the inductor wiring line while preventing a short circuit between different portions of the inductor wiring line.

### BRIEF DESCRIPTION OF THE DRAWINGS

FIG. 1 is a perspective view of an inductor component of a first embodiment;

FIG. 2 is a transparent side view of the inductor component of the first embodiment;

FIG. 3 is a cross-sectional view taken along line 3-3 in FIG. 2;

FIG. 4 is a cross-sectional view taken along line 4-4 in FIG. 2;

FIG. 5 is a cross-sectional view taken along line 5-5 in FIGS. 3 and 4;

FIG. 6 is a flowchart of the manufacturing steps for the inductor component of the first embodiment;

FIG. 7 is an explanatory diagram for the method of manufacturing the inductor component of the first embodiment;

FIG. 8 is an explanatory diagram for the method of manufacturing the inductor component of the first embodiment;

FIG. 9 is an explanatory diagram for the method of manufacturing the inductor component of the first embodiment;

FIG. 10 is an explanatory diagram for the method of manufacturing the inductor component of the first embodiment;

FIG. 11 is an explanatory diagram for the method of manufacturing the inductor component of the first embodiment;

FIG. 12 is an explanatory diagram for the method of manufacturing the inductor component of the first embodiment;

FIG. 13 is an explanatory diagram for the method of manufacturing the inductor component of the first embodiment;

FIG. 14 is an explanatory diagram for the method of manufacturing the inductor component of the first embodiment;

FIG. 15 is an explanatory diagram for the method of manufacturing the inductor component of the first embodiment;

FIG. 16 is an explanatory diagram for the method of manufacturing the inductor component of the first embodiment;

FIG. 17 is an explanatory diagram for the method of manufacturing the inductor component of the first embodiment;

FIG. 18 is an explanatory diagram for the method of manufacturing the inductor component of the first embodiment;

FIG. 19 is an explanatory diagram for the method of manufacturing the inductor component of the first embodiment;

FIG. 20 is an explanatory diagram for the method of manufacturing the inductor component of the first embodiment;

FIG. 21 is an explanatory diagram for the method of manufacturing the inductor component of the first embodiment;

FIG. 22 is an explanatory diagram for the method of manufacturing the inductor component of the first embodiment;

FIG. 23 is an explanatory diagram for the method of manufacturing the inductor component of the first embodiment;

FIG. 24 is an explanatory diagram for the method of manufacturing the inductor component of the first embodiment;

FIG. 25 is a perspective view of an inductor component of a second embodiment;

FIG. 26 is a transparent top view of the inductor component of the second embodiment;

FIG. 27 is a cross-sectional view taken along line 27-27 in FIG. 26;

FIG. 28 is a flowchart of the manufacturing steps for the inductor component of the second embodiment;

FIG. 29 is an explanatory diagram for the method of manufacturing the inductor component of the second embodiment;

FIG. 30 is an explanatory diagram for the method of manufacturing the inductor component of the second embodiment;

FIG. 31 is an explanatory diagram for the method of manufacturing the inductor component of the second embodiment;

FIG. 32 is an explanatory diagram for the method of manufacturing the inductor component of the second embodiment;

FIG. 33 is an explanatory diagram for the method of manufacturing the inductor component of the second embodiment;

FIG. 34 is an explanatory diagram for the method of manufacturing the inductor component of the second embodiment;

FIG. 35 is an explanatory diagram for the method of manufacturing the inductor component of the second embodiment;

FIG. 36 is an explanatory diagram for the method of manufacturing the inductor component of the second embodiment;

FIG. 37 is a perspective view of an inductor component of a modification;

FIG. 38 is a transparent top view of the inductor component of the modification;

FIG. 39 is a cross-sectional view of an inductor component of a modification;

FIG. 40 is a cross-sectional view of an inductor component of a modification; and

FIG. 41 is an explanatory diagram for a method of manufacturing an inductor component of a modification.

### DETAILED DESCRIPTION

Hereinafter, inductor components of embodiments will be described with reference to the drawings. The drawings may show certain structural elements in an enlarged manner for ease of understanding. The ratios of dimensions of structural elements are not consistent with those of actual ones or those in other drawings in some cases.

### Inductor Component of First Embodiment

The following describes an inductor component and a method of manufacturing an inductor component according to the first embodiment.

### Overall Configuration

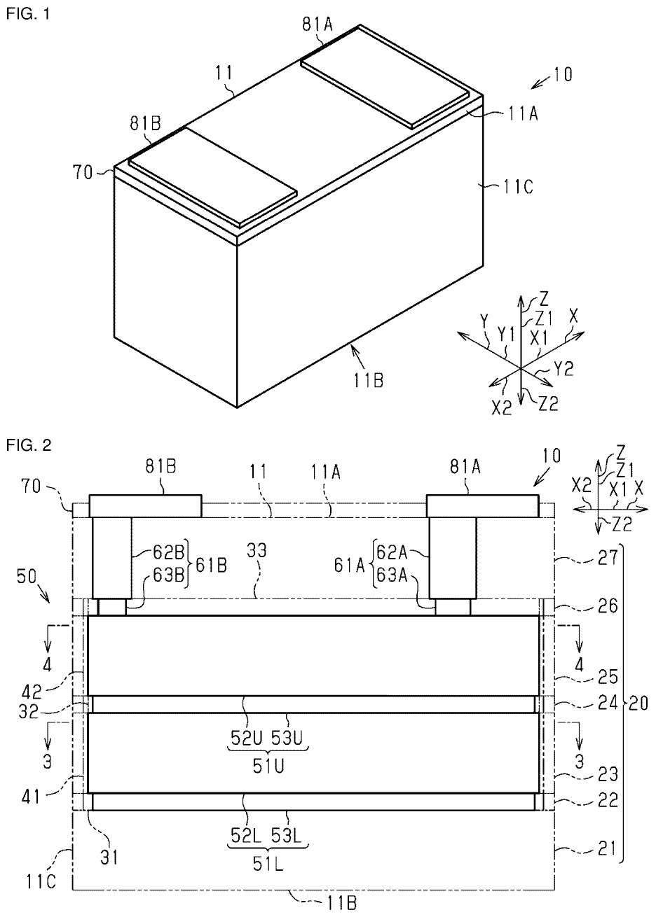

As illustrated in FIG. 1, an inductor component 10 has an approximately rectangular parallelepiped shape as a whole. The inductor component 10 includes an element body 11.

The element body 11 has an approximately rectangular parallelepiped shape. In other words, the element body 11 has six planar outer surfaces. Of the six outer surfaces, a specific one surface is defined as the first main surface 11A. The surface located opposite to the first main surface 11A and parallel to the first main surface 11A is defined as the second main surface 11B. The four surfaces perpendicular to the first main surface 11A, in other words, the outer surfaces other than the first main surface 11A and the second main surface 11B are defined as the side surfaces 11C of the element body 11. The outer shape of the first main surface 11A, the outer shape of the second main surface 11B, the outer shape of each side surface 11C of the element body 11 are all rectangular.

The axis parallel to the long-side edges of the first main surface 11A is defined as the first axis X. The axis parallel to the short-side edges of the first main surface 11A is defined as the second axis Y. The axis perpendicular to the first main surface 11A is defined as the third axis Z. In the present embodiment, the first axis X, the second axis Y, and the third axis Z are orthogonal to one another. A specific one direction along the first axis X is defined as the first positive direction X1, and the direction opposite to the first positive direction X1 as the first negative direction X2. A specific one direction along the second axis Y is defined as the second positive direction Y1, and the direction opposite to the second positive direction Y1 as the second negative direction Y2. In addition, the direction along the third axis Z that the first main surface 11A faces is defined as the third positive direction Z1, and the direction opposite to the third positive direction Z1 as the third negative direction Z2.

As illustrated in FIG. 2, the element body 11 includes, as a magnetic layer 20, a first magnetic layer 21, a first interlayer magnetic layer 22, a second magnetic layer 23, a second interlayer magnetic layer 24, a third magnetic layer 25, a third interlayer magnetic layer 26, and a fourth magnetic layer 27 in this order from the third negative direction Z2 side. In other words, of the outer surfaces of the fourth magnetic layer 27, the outer surface facing the third positive direction Z1 is the first main surface 11A. Of the outer surfaces of the first magnetic layer 21, the outer surface facing the third negative direction Z2 is the second main surface 11B. In FIG. 2, the boundaries between the layers in the magnetic layer 20 are indicated illustratively by dashed double-dotted lines. In actual cases, clear boundaries are not observed between the layers in the magnetic layer 20 in some cases.

The material of the magnetic layer 20, in other words, the material of the element body 11 contains a magnetic material. Specifically, the material of the element body 11 is an organic resin containing metal magnetic powder. In the present embodiment, the metal magnetic powder is composed of an Fe-based alloy or an amorphous alloy. More specifically, the metal magnetic powder is an FeSiCr-based metal powder containing iron.

The inductor component 10 includes three insulating layers. The three insulating layers are referred to as a first insulating layer 31, a second insulating layer 32, and a third insulating layer 33. The material of each insulating layer is an insulating resin.

The first insulating layer 31 extends along a plane parallel to the first main surface 11A in the element body 11. The first insulating layer 31 is in contact with the surface of the first magnetic layer 21 on the third positive direction Z1 side. In the third axis Z direction, the position of the first insulating layer 31 is the same as that of the first interlayer magnetic layer 22.

The second insulating layer 32 extends along a plane parallel to the first main surface 11A in the element body 11. In the third axis Z direction, the position of the second insulating layer 32 is the same as that of the second interlayer magnetic layer 24. The third insulating layer 33 extends along a plane parallel to the first main surface 11A in the element body 11. The third insulating layer 33 is in contact with the surface of the fourth magnetic layer 27 on the third negative direction Z2 side. In the third axis Z direction, the position of the third insulating layer 33 is the same as that of the third interlayer magnetic layer 26. Note that the term “parallel” means “substantially parallel”, allowing manufacturing deviations. For example, if an acute angle between the first insulating layer 31 and the first main surface 11A is less than 5 degrees, they shall be regarded as being parallel.

As illustrated in FIG. 2, the inductor component 10 includes an inductor wiring line 50. The inductor wiring line 50 is located in the element body 11. The material of the inductor wiring line 50 is a conductive material. In the present embodiment, the composition of the inductor wiring line 50 contains 99 wt % or more of copper and 0.1 wt % or more and 1.0 wt % or less (i.e., from 0.1 wt % to 1.0 wt %) of sulfur.

The inductor wiring line 50 includes an upper inductor wiring line 51U and a lower inductor wiring line 51L. The lower inductor wiring line 51L extends parallel to the first main surface 11A. The lower inductor wiring line 51L is located in the same layers as the first insulating layer 31 and the second magnetic layer 23 in the third axis Z direction. Specifically, the outer surface of the lower inductor wiring line 51L on the third negative direction Z2 side is in contact with the outer surface of the first magnetic layer 21 on the third positive direction Z1 side. On the outer surface of the lower inductor wiring line 51L on the third positive direction Z1 side, the second insulating layer 32 and the upper inductor wiring line 51U are located.

The lower inductor wiring line 51L includes a lower wiring main portion 52L. The lower wiring main portion 52L is a portion of the lower inductor wiring line 51L located in the same layer as the second magnetic layer 23 in the third axis Z direction. Thus, the lower wiring main portion 52L extends on the outer surface of the first insulating layer 31 on the third positive direction Z1 side. In other words, the outer surface of the lower wiring main portion 52L on the third negative direction Z2 side is in contact with the outer surface of the first insulating layer 31 on the third positive direction Z1 side.

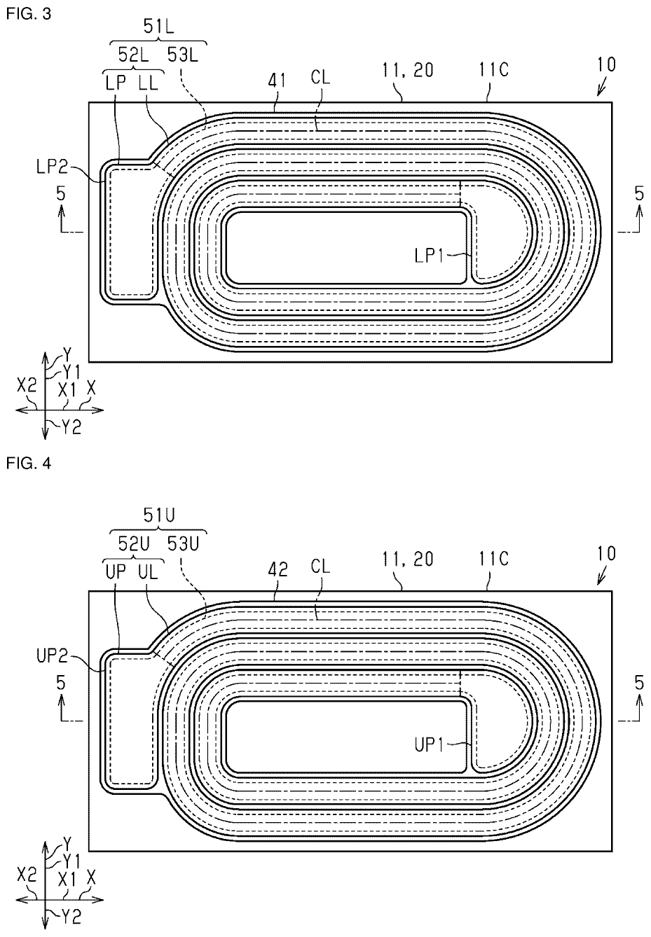

As illustrated in FIG. 3, in a transparent view of the inductor component 10 in the third negative direction Z2, the lower inductor wiring line 51L extends in a spiral shape. The outer edge of the lower inductor wiring line 51L is spaced from the side surfaces 11C of the element body 11. Hence, the lower inductor wiring line 51L is not exposed on the side surfaces 11C of the element body 11. In addition, in this embodiment, no other conductive member that reaches the side surfaces 11C of the element body 11 is connected to the lower inductor wiring line 51L. Hence, no conductive member electrically connected to the lower inductor wiring line 51L is exposed on the side surfaces 11C of the element body 11.

The lower wiring main portion 52L includes a pair of lower pad portions LP and a lower wiring portion LL. The lower pad portions LP are located at both end portions of the lower wiring main portion 52L. Of the pair of lower pad portions LP, the lower pad portion LP located on the first positive direction X1 side is referred to as the lower-inner pad portion LP1. Relative to the lower-inner pad portion LP1, the lower pad portion LP located on the first negative direction X2 side is referred to as the lower-outer pad portion LP2. In other words, in a transparent view in the third negative direction Z2, the lower-inner pad portion LP1 is located in the first positive direction X1 relative the geometric center of the element body 11. The lower-outer pad portion LP2 is located in the first negative direction X2 relative to the lower-inner pad portion LP1.

The lower wiring portion LL connects the pair of lower pad portions LP. Specifically, in a transparent view of the inductor component 10 in the third negative direction Z2, the lower wiring portion LL extends from the lower-inner pad portion LP1 toward the lower-outer pad portion LP2 counterclockwise such that the radius increases as the number of turns increases. The number of turns of the lower wiring portion LL is approximately 2.0 turns.

Note that the number of turns of the lower wiring portion LL is determined based on a virtual vector as follows. First, a vector is virtually assumed whose starting point and end point are both a first end of the center line CL of the lower wiring portion LL. In this state, the vector is a zero vector. Then, in a state of viewing in the third negative direction Z2, while the starting point of the vector is fixed, the end point of the vector is moved to the second end of the center line CL along the center line CL of the lower wiring portion LL. During this process, the number of turns is calculated such that when the direction of the vector turns by 360 degrees, the number of turns is regarded as 1.0 turn. For example, in the case where the virtual vector turns by 180 degrees, the number of turns is counted as 0.5 turns.

The width dimension of the lower wiring portion LL in the direction perpendicular to the center line CL and parallel to the first main surface 11A is approximately constant over the entire lower wiring portion LL. The center line CL of the lower wiring portion LL is determined as follows. In a transparent view in the third negative direction Z2, of the line segments connecting a certain point on the outer edge of the lower wiring portion LL and a point on the outer edge on the opposite side, the line segment having the shortest distance between the two points is identified. In the manner as described above, such line segments are identified over the entire region of the outer edge of the lower wiring portion LL, and a line connecting the midpoints of the identified line segments is defined as the center line CL of the lower wiring portion LL in a transparent view in the third negative direction Z2.

As illustrated in FIG. 2, the upper inductor wiring line 51U extends parallel to the first main surface 11A. The upper inductor wiring line 51U is located in the same layers as the second insulating layer 32 and the third magnetic layer 25 in the third axis Z direction. The outer surface of the upper inductor wiring line 51U on the third negative direction Z2 side is in contact with the outer surface of the lower inductor wiring line 51L on the third positive direction Z1 side. On the outer surface of the upper inductor wiring line 51U on the third positive direction Z1 side, the third insulating layer 33 is located.

The upper inductor wiring line 51U includes an upper wiring main portion 52U. The upper wiring main portion 52U is a portion of the upper inductor wiring line 51U located in the same layer as the third magnetic layer 25 in the third axis Z direction. Thus, the upper wiring main portion 52U extends on the outer surface of the second insulating layer 32 on the third positive direction Z1 side. In other words, the outer surface of the upper wiring main portion 52U on the third negative direction Z2 side is in contact with the outer surface of the second insulating layer 32 on the third positive direction Z1 side.

The shape of the upper inductor wiring line 51U is the same as that of the lower inductor wiring line 51L. Specifically, as illustrated in FIG. 4, in a transparent view of the inductor component 10 in the third negative direction Z2, the upper inductor wiring line 51U extends in a spiral shape. The outer edge of the upper inductor wiring line 51U is spaced from the side surfaces 11C of the element body 11. Hence, the upper inductor wiring line 51U is not exposed on the side surfaces 11C of the element body 11. In addition, in this embodiment, no other conductive member that reaches the side surfaces 11C of the element body 11 is connected to the upper inductor wiring line 51U. Hence, no conductive member electrically connected to the upper inductor wiring line 51U is exposed on the side surfaces 11C of the element body 11.

The upper wiring main portion 52U includes a pair of upper pad portions UP and an upper wiring portion UL. The upper pad portions UP are located at both end portions of the upper wiring main portion 52U. Of the pair of upper pad portions UP, the upper pad portion UP located on the first positive direction X1 side is referred to as the upper-inner pad portion UP1. Relative to the upper-inner pad portion UP1, the upper pad portion UP located on the first negative direction X2 side is referred to as the upper-outer pad portion UP2. In other words, the upper-inner pad portion UP1 is located in the third positive direction Z1 relative to the lower-inner pad portion LP1. The upper-outer pad portion UP2 is located in the third positive direction Z1 relative to the lower-outer pad portion LP2. The shape of each upper pad portion UP is the same as that of the corresponding lower pad portion LP.

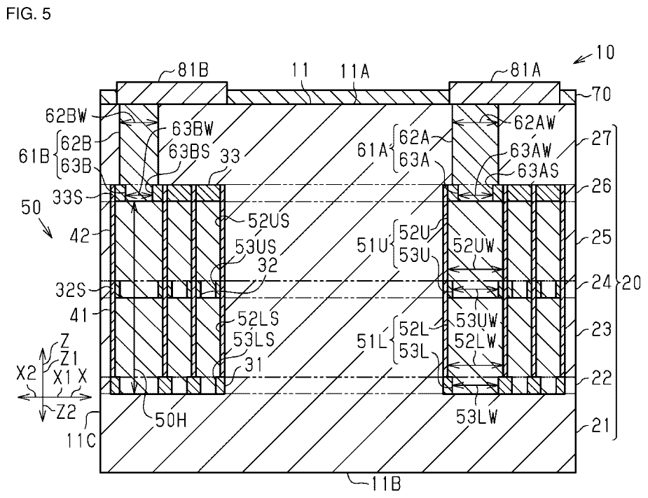

As illustrated in FIG. 5, the minimum width dimension 52UW of the upper wiring main portion 52U is the same as the minimum width dimension 52LW of the lower wiring main portion 52L. The minimum width dimension 52UW of the upper wiring main portion 52U refers to the minimum dimension of the upper wiring main portion 52U in the direction orthogonal to the center line CL of the upper wiring main portion 52U and parallel to the first main surface 11A. In this embodiment, the minimum width dimension 52UW is the dimension of the upper wiring portion UL in the direction mentioned above. Similarly, the minimum width dimension 52LW of the lower wiring main portion 52L refers to the minimum dimension of the lower wiring main portion 52L in the direction orthogonal to the center line CL of the lower wiring main portion 52L and parallel to the first main surface 11A. In this embodiment, the minimum width dimension 52LW is the dimension of the lower wiring portion LL in the direction mentioned above.

The upper wiring portion UL connects the pair of upper pad portions UP. Specifically, in a transparent view of the inductor component 10 in the third negative direction Z2, the upper wiring portion UL extends from the upper-inner pad portion UP1 toward the upper-outer pad portion UP2 counterclockwise such that the radius increases as the number of turns increases. The number of turns of the upper wiring portion UL is the same as that of the lower wiring portion LL. Specifically, the number of turns of the upper wiring portion UL is approximately 2.0 turns. The definition of the number of turns is the same as that of the lower wiring portion LL.

As illustrated in FIG. 5, the total height dimension 50H of the inductor wiring line 50 is at least twice the minimum width dimension 52LW of the lower wiring main portion 52L. Similarly, the total height dimension 50H of the inductor wiring line 50 is at least twice the minimum width dimension 52UW of the upper wiring main portion 52U. In the present embodiment, the total height dimension 50H of the inductor wiring line 50 is approximately four times the minimum width dimension 52LW of the lower wiring main portion 52L or the minimum width dimension 52UW of the upper wiring main portion 52U. The total height dimension 50H mentioned here is the sum of the maximum dimension of the lower inductor wiring line 51L and the maximum dimension of the upper inductor wiring line 51U in the direction orthogonal to the first main surface 11A.

As illustrated in FIG. 5, the inductor component 10 includes a lower resin wall 41 and an upper resin wall 42. The material of each resin wall is an insulating resin.

The lower resin wall 41 is laminated on part of the surface of the first insulating layer 31 on the third positive direction Z1 side. The lower resin wall 41 is located in the same layer as the lower wiring main portion 52L and the second magnetic layer 23 in the third axis Z direction. The lower resin wall 41 covers the side surface 52LS of the lower wiring main portion 52L among the outer surfaces of the lower inductor wiring line 51L. The lower resin wall 41 extends in the third axis Z direction to reach the same layer as the layer in which the second interlayer magnetic layer 24 and the second insulating layer 32 are located. Specifically, the lower resin wall 41 is also in contact with the side surface 32S of the second interlayer magnetic layer 24 and the second insulating layer 32. Note that the side surface 52LS of the lower wiring main portion 52L refers to the outer surfaces of the lower wiring main portion 52L other than the outer surface on the third positive direction Z1 side and the outer surface on the third negative direction Z2 side. The side surface 32S of the second insulating layer 32 refers to the outer surfaces of the second insulating layer 32 other than the outer surface on the third positive direction Z1 side and the outer surface on the third negative direction Z2 side.

The upper resin wall 42 is laminated on the surface of the lower resin wall 41 on the third positive direction Z1 side. The upper resin wall 42 is located in the same layer as the upper wiring main portion 52U and the third magnetic layer 25 in the third axis Z direction. The upper resin wall 42 covers the side surface 52US of the upper wiring main portion 52U among the outer surfaces of the upper inductor wiring line 51U. The upper resin wall 42 extends in the third axis Z direction to reach the same layer as the layer in which the third interlayer magnetic layer 26 and the third insulating layer 33 are located. Specifically, the upper resin wall 42 is also in contact with the side surface 33S of the third interlayer magnetic layer 26 and the third insulating layer 33. Note that the side surface 52US of the upper wiring main portion 52U refers to the outer surfaces of the upper wiring main portion 52U other than the outer surface on the third positive direction Z1 side and the outer surface on the third negative direction Z2 side. The side surface 33S of the third insulating layer 33 refers to the outer surfaces of the third insulating layer 33 other than the outer surface on the third positive direction Z1 side and the outer surface on the third negative direction Z2 side.

In the illustration in FIG. 5, the outer surface of the upper resin wall 42 on the third positive direction Z1 side is in contact with the outer surface of the fourth magnetic layer 27 on the third negative direction Z2 side. In practice, the outer surface of the upper resin wall 42 on the third positive direction Z1 side may be located within the third insulating layer 33 without being in contact with the outer surface of the fourth magnetic layer 27 on the third negative direction Z2 side.

The inductor component 10 includes a first columnar wiring line 61A and a second columnar wiring line 61B. The material of each columnar wiring line is the same as the material of the inductor wiring line 50. Each columnar wiring line extends in a direction intersecting the first main surface 11A. Each columnar wiring line is located in the same layers as the third interlayer magnetic layer 26 and the fourth magnetic layer 27 in the third axis Z direction. Each columnar wiring line extends in the direction orthogonal to the first main surface 11A, in other words, in the third axis Z direction.

Each columnar wiring line is in contact with the outer surface of the upper wiring main portion 52U on the third positive direction Z1 side. Thus, each columnar wiring line is electrically connected to the inductor wiring line 50. Specifically, the outer surface of the first columnar wiring line 61A on the third negative direction Z2 side is in contact with the surface of the upper-inner pad portion UP1 parallel to the first main surface 11A. The outer surface of the second columnar wiring line 61B on the third negative direction Z2 side is in contact with the surface of the upper-outer pad portion UP2 parallel to the first main surface 11A.

The inductor component 10 includes a first outer electrode 81A and a second outer electrode 81B. Each outer electrode is located on the first main surface 11A of the element body 11. Specifically, each outer electrode covers part of an outer surface of the element body 11.

The first outer electrode 81A is located in the first positive direction X1 relative to the geometric center of the first main surface 11A on the first main surface 11A. The second outer electrode 81B is located in the first negative direction X2 relative to the geometric center of the first main surface 11A on the first main surface 11A. The first outer electrode 81A is in contact with the surface of the first columnar wiring line 61A facing the third positive direction Z1. The second outer electrode 81B is in contact with the surface of the second columnar wiring line 61B facing the third positive direction Z1.

The inductor component 10 includes a solder resist 70. The solder resist 70 has higher insulation than the element body 11. The solder resist 70 covers the surface of the element body 11 on the third positive direction Z1 side excluding at least two outer electrodes. Since the first main surface 11A of the element body 11 is covered with the outer electrodes and the solder resist 70, the first main surface 11A is not exposed to the outside. Note that the entire outer surface of the solder resist 70 on the third positive direction Z1 side need not be exposed. For example, part of each outer electrode may cover part of the outer surface of the solder resist 70 on the third positive direction Z1 side.

### Protruding Portions

Next, details of the configuration of the inductor wiring line 50 will be described.

As illustrated in FIG. 5, the lower inductor wiring line 51L includes a lower protruding portion 53L, in addition to the lower wiring main portion 52L. The lower inductor wiring line 51L is formed in a single step by electrolytic plating in the manufacturing method described later. In other words, the lower wiring main portion 52L and the lower protruding portion 53L are formed as an integral structure.

The lower protruding portion 53L is a portion of the lower inductor wiring line 51L located in the same layer as the first interlayer magnetic layer 22 in the third axis Z direction. The lower protruding portion 53L protrudes in the third negative direction Z2 from the outer surface of the lower wiring main portion 52L on the third negative direction Z2 side. Specifically, the lower protruding portion 53L protrudes from both the lower wiring portion LL and the lower pad portions LP. The lower protruding portion 53L passes through the first insulating layer 31. In the present embodiment, the dimension of the lower protruding portion 53L is the same as the dimension of the first insulating layer 31 in the third axis Z direction. Hence, the position of the lower protruding portion 53L, the position of the first insulating layer 31, and the position of the first interlayer magnetic layer 22 are the same in the third axis Z direction.

The outer surface of the lower protruding portion 53L on the third negative direction Z2 side is in contact with the element body 11. The side surface 53LS of the lower protruding portion 53L is in contact with the first insulating layer 31. Note that the side surface 53LS of the lower protruding portion 53L refers to the outer surfaces of the lower protruding portion 53L other than the outer surface on the third negative direction Z2 side. In this case, since the lower protruding portion 53L protrudes from the lower wiring main portion 52L, the lower protruding portion 53L does not have an outer surface on the third positive direction Z1 side.

As illustrated in FIG. 3, in a transparent view in the third positive direction Z1, the lower protruding portion 53L extends along the lower wiring main portion 52L. Specifically, the lower protruding portion 53L extends from the lower-inner pad portion LP1 via the lower wiring portion LL to the lower-outer pad portion LP2. In other words, the lower protruding portion 53L extends along approximately the entire region of the lower wiring main portion 52L. In a transparent view in the third positive direction Z1, the lower protruding portion 53L is located within the region surrounded by the outer edge of the lower wiring main portion 52L. More specifically, as illustrated in FIG. 5, in a cross-sectional view taken along a cross section orthogonal to the first main surface 11A, the dimension of each portion of the lower inductor wiring line 51L in the direction parallel to the first main surface 11A is defined as its width dimension. In this case, the width dimension 53LW of the lower protruding portion 53L is smaller than the width dimension of the lower wiring main portion 52L at the position where the lower protruding portion 53L is connected in the same cross section. Note that in FIG. 5, the width dimension of the lower wiring main portion 52L is the minimum width dimension 52LW. In other words, the width dimension 53LW of the lower protruding portion 53L is smaller than the minimum width dimension 52LW of the lower wiring main portion 52L at the position where the lower protruding portion 53L is connected in the same cross section.

As illustrated in FIG. 5, the upper inductor wiring line 51U includes an upper protruding portion 53U, in addition to the upper wiring main portion 52U. The upper inductor wiring line 51U is formed in a single step by electrolytic plating in the manufacturing method described later. In other words, the upper wiring main portion 52U and the upper protruding portion 53U are formed as an integral structure.

The upper protruding portion 53U is a portion of the upper inductor wiring line 51U located in the same layer as the second interlayer magnetic layer 24 in the third axis Z direction. The upper protruding portion 53U protrudes in the third negative direction Z2 from the outer surface of the upper wiring main portion 52U on the third negative direction Z2 side. Specifically, the upper protruding portion 53U protrudes from both the upper wiring portion UL and the upper pad portions UP. The upper protruding portion 53U passes through the second insulating layer 32. In the present embodiment, the dimension of the upper protruding portion 53U is the same as the dimension of the second insulating layer 32 in the third axis Z direction. Hence, the position of the upper protruding portion 53U, the position of the second insulating layer 32, and the position of the second interlayer magnetic layer 24 are the same in the third axis Z direction.

The outer surface of the upper protruding portion 53U on the third negative direction Z2 side is in contact with the outer surface of the lower wiring main portion 52L on the third positive direction Z1 side. The side surface 53US of the upper protruding portion 53U is in contact with the second insulating layer 32. Note that the side surface 53US of the upper protruding portion 53U refers to the outer surfaces of the upper protruding portion 53U other than the outer surface on the third negative direction Z2 side. In this case, since the upper protruding portion 53U protrudes from the upper wiring main portion 52U, the upper protruding portion 53U does not have an outer surface on the third positive direction Z1 side.

In a transparent view in the third positive direction Z1, the upper protruding portion 53U extends along the upper wiring main portion 52U. Specifically, the upper protruding portion 53U extends from the upper-inner pad portion UP1 via the upper wiring portion UL to the upper-outer pad portion UP2. In other words, the upper protruding portion 53U extends along approximately the entire region of the upper wiring main portion 52U. As illustrated in FIG. 4, in a transparent view in the third positive direction Z1, the upper protruding portion 53U is located within the region surrounded by the outer edge of the upper wiring main portion 52U. More specifically, as illustrated in FIG. 5, in a cross-sectional view taken along a cross section orthogonal to the first main surface 11A, the dimension of each portion of the upper inductor wiring line 51U in the direction parallel to the first main surface 11A is defined as its width dimension. In this case, the width dimension 53UW of the upper protruding portion 53U is smaller than the width dimension of the upper wiring main portion 52U at the position where the upper protruding portion 53U is connected in the same cross section. Note that in FIG. 5, the width dimension of the upper wiring main portion 52U is the minimum width dimension 52UW. In other words, the width dimension 53UW of the upper protruding portion 53U is smaller than the minimum width dimension 52UW of the upper wiring main portion 52U at the position where the upper protruding portion 53U is connected in the same cross section.

### Extended Portions

Next, details of the configuration of each columnar wiring line will be described.

As illustrated in FIG. 5, the first columnar wiring line 61A includes a first columnar portion 62A and a first extended portion 63A. The first columnar wiring line 61A is formed in a single step by electrolytic plating in the manufacturing method described later. Thus, the first columnar portion 62A and the first extended portion 63A are formed as an integral structure. The shapes of the first columnar portion 62A and the first extended portion 63A are both approximately semicircular columnar shapes corresponding to the shape of the upper-inner pad portion UP1.

The first columnar portion 62A is a portion of the first columnar wiring line 61A located in the same layer as the fourth magnetic layer 27 in the third axis Z direction. The first columnar portion 62A extends in the third positive direction Z1 from the outer surface of the third insulating layer 33 on the third positive direction Z1 side. In other words, the outer surface of the first columnar portion 62A on the third negative direction Z2 side is in contact with the outer surface of the third insulating layer 33 on the third positive direction Z1 side.

The first extended portion 63A is a portion located in the same layer as the third interlayer magnetic layer 26 in the third axis Z direction. The first extended portion 63A protrudes in the third negative direction Z2 from the outer surface of the first columnar portion 62A on the third negative direction Z2 side. The first extended portion 63A passes through the third insulating layer 33. The dimension of the first extended portion 63A is the same as the dimension of the third insulating layer 33 in the third axis Z direction. Hence, the position of the first extended portion 63A, the position of the third insulating layer 33, and the position of the third interlayer magnetic layer 26 are the same in the third axis Z direction.

The outer surface of the first extended portion 63A on the third negative direction Z2 side, which is its one end, is in contact with the surface of the upper-inner pad portion UP1 parallel to the first main surface 11A. The outer edge of the first extended portion 63A is parallel to the outer edge of the upper-inner pad portion UP1. In a transparent view in the third positive direction Z1, the outer edge of the first extended portion 63A is parallel to the outer edge of the first columnar portion 62A. In addition, in a transparent view in the third positive direction Z1, the area of the region surrounded by the outer edge of the first columnar portion 62A is smaller than or equal to 1.3 times the area of the region surrounded by the outer edge of the first extended portion 63A.

The side surface 63AS of the first extended portion 63A is in contact with the third insulating layer 33. The side surface 63AS of the first extended portion 63A refers to the outer surfaces of the first extended portion 63A other than the outer surface on the third negative direction Z2 side. In this case, since the first extended portion 63A protrudes from the first columnar portion 62A, the first extended portion 63A does not have an outer surface on the third positive direction Z1 side.

In a cross-sectional view taken along a cross section orthogonal the first main surface 11A, the dimension of each portion of the first columnar wiring line 61A in the direction parallel to the first main surface 11A is defined as the width dimension of the first columnar wiring line 61A at the portion. The width dimension 63AW of the first extended portion 63A is smaller than the width dimension 62AW of the first columnar portion 62A at the position where the first extended portion 63A is connected in the same cross section.

The second columnar wiring line 61B includes a second columnar portion 62B and a second extended portion 63B. The second columnar wiring line 61B is formed in a single step by electrolytic plating in the manufacturing method described later. Thus, the second columnar portion 62B and the second extended portion 63B are formed as an integral structure. The shapes of the second columnar portion 62B and the second extended portion 63B are both approximately square columnar shapes corresponding to the shape of the upper-inner pad portion UP1.

The second columnar portion 62B is a portion of the second columnar wiring line 61B located in the same layer as the fourth magnetic layer 27 in the third axis Z direction. The second columnar portion 62B extends in the third positive direction Z1 from the outer surface of the third insulating layer 33 on the third positive direction Z1 side. In other words, the outer surface of the second columnar portion 62B on the third negative direction Z2 side is in contact with the outer surface of the third insulating layer 33 on the third positive direction Z1 side.

The second extended portion 63B is a portion located in the same layer as the third interlayer magnetic layer 26 in the third axis Z direction. The second extended portion 63B protrudes in the third negative direction Z2 from the outer surface of the second columnar portion 62B on the third negative direction Z2 side. The second extended portion 63B passes through the third insulating layer 33. The dimension of the second extended portion 63B is the same as the dimension of the third insulating layer 33 in the third axis Z direction. Hence, the position of the second extended portion 63B, the position of the third insulating layer 33, the position of the third interlayer magnetic layer 26, and the position of the first extended portion 63A are the same in the third axis Z direction.

The outer surface of the second extended portion 63B on the third negative direction Z2 side, which is its one end, is in contact with the surface of the upper-outer pad portion UP2 parallel to the second main surface 11B. The outer edge of the second extended portion 63B is parallel to the outer edge of the upper-outer pad portion UP2. In a transparent view in the third positive direction Z1, the outer edge of the second extended portion 63B is parallel to the outer edge of the second columnar portion 62B. In addition, in a transparent view in the third positive direction Z1, the area of the region surrounded by the outer edge of the second columnar portion 62B is smaller than or equal to 1.3 times the area of the region surrounded by the outer edge of the second extended portion 63B.

The side surface 63BS of the second extended portion 63B is in contact with the third insulating layer 33. The side surface 63BS of the second extended portion 63B refers to the outer surfaces of the second extended portion 63B other than the outer surface on the third negative direction Z2 side. In this case, since the second extended portion 63B protrudes from the second columnar portion 62B, the second extended portion 63B does not have an outer surface on the third positive direction Z1.

In a cross-sectional view taken along a cross section orthogonal the first main surface 11A, the dimension of each portion of the second columnar wiring line 61B in the direction parallel to the first main surface 11A is defined as the width dimension of the second columnar wiring line 61B at the portion. The width dimension 63BW of the second extended portion 63B is smaller than the width dimension 62BW of the second columnar portion 62B at the position where the second extended portion 63B is connected in the same cross section.

### Manufacturing Method

Next, a method of manufacturing the inductor component 10 according to the first embodiment will be described. The method of manufacturing the inductor component 10 employs a so-called semi-additive process (SAP).

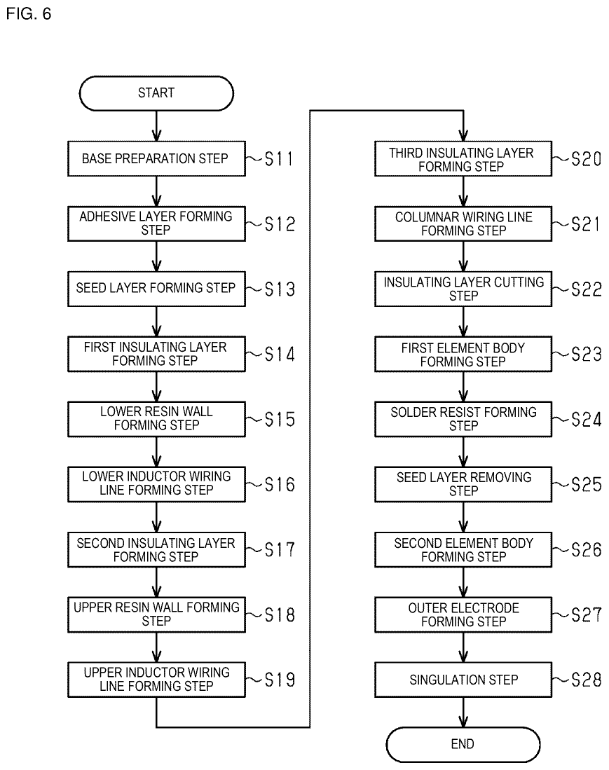

As illustrated in FIG. 6, the method of manufacturing the inductor component 10 includes the following 18 steps. Specifically, the method of manufacturing the inductor component 10 includes a base preparation step S11, an adhesive layer forming step S12, a seed layer forming step S13, a first insulating layer forming step S14, a lower resin wall forming step S15, a lower inductor wiring line forming step S16, a second insulating layer forming step S17, an upper resin wall forming step S18, an upper inductor wiring line forming step S19, a third insulating layer forming step S20, a columnar wiring line forming step S21, an insulating layer cutting step S22, a first element body forming step S23, a solder resist forming step S24, a seed layer removing step S25, a second element body forming step S26, an outer electrode forming step S27, and a singulation step S28.

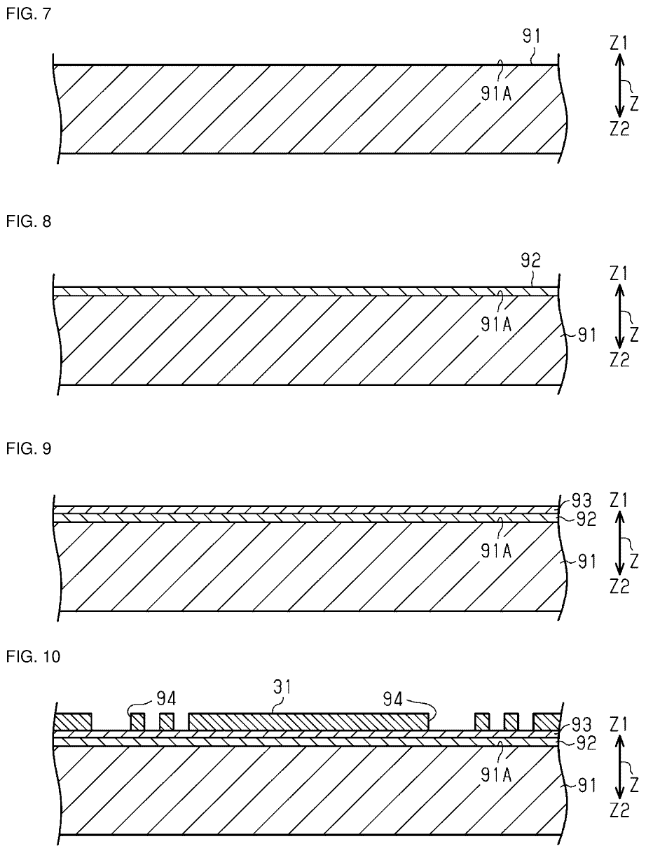

As illustrated in FIG. 7, first, the base preparation step S11 is performed. Specifically, a plate-shaped base substrate 91 is prepared. The material of the base substrate 91 is a ceramic. A main surface 91A of the base substrate 91 has a dimension that enables a plurality of inductor components 10 to be formed.

The axis orthogonal to the main surface 91A of the base substrate 91 is defined as the third axis Z. In addition, the direction along the third axis Z that the first main surface 11A faces is defined as the third positive direction Z1, and the direction opposite to the third positive direction Z1 as the third negative direction Z2. In other words, the third positive direction Z1 is the “upward direction”, and the third negative direction Z2 is the “downward direction”. That is, an “upper surface” is a surface facing the third positive direction Z1. A “lower surface” is a surface facing the third negative direction Z2. Note that the third positive direction Z1 during the manufacturing of the inductor component 10 corresponds to the third positive direction Z1 in the inductor component 10 after manufacturing. In this regard, the same applies to the third negative direction Z2.

Next, as illustrated in FIG. 8, the adhesive layer forming step S12 is performed. In the adhesive layer forming step S12, an adhesive layer 92 having adhesiveness is applied on the main surface 91A of the base substrate 91. Specifically, the material of the adhesive layer 92 is a resin such as polyimide.

Next, as illustrated in FIG. 9, the seed layer forming step S13 is performed. In the seed layer forming step S13, a seed layer 93 having conductivity is formed over the main surface 91A of the base substrate 91. Specifically, the seed layer 93 is formed on the upper surface of the adhesive layer 92 by sputtering. The material of the seed layer 93 is copper. Note that the seed layer 93 formed in the seed layer forming step S13 in this embodiment is not a so-called patterned layer. For example, the seed layer 93 is formed over the entire main surface 91A of the base substrate 91.

Next, as illustrated in FIG. 10, the first insulating layer forming step S14 is performed. In the first insulating layer forming step S14, the first insulating layer 31 having a first opening 94 corresponding to a specified wiring pattern is formed on the upper surface of the seed layer 93 by photolithography. The position and shape of the first opening 94 correspond to the position and shape of the lower protruding portion 53L of the lower inductor wiring line 51L to be formed in a later step. The region of the first opening 94 is slightly smaller than the region where the lower wiring main portion 52L is to be formed. Hence, the “specified wiring pattern” in the first insulating layer forming step S14 refers to the position and shape along the lower inductor wiring line 51L to be formed in the lower inductor wiring line forming step S16.

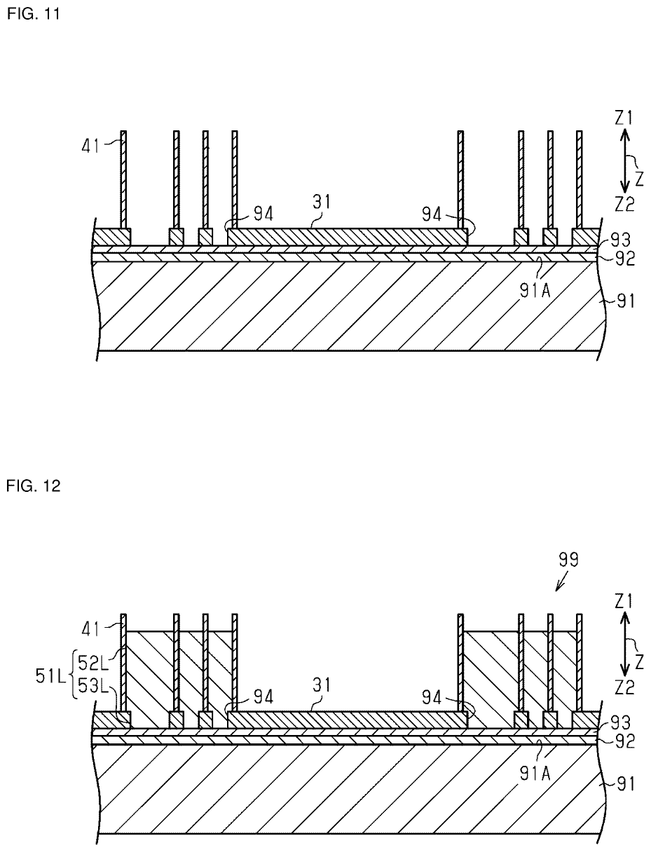

Next, as illustrated in FIG. 11, the lower resin wall forming step S15 is performed. In the lower resin wall forming step S15, the lower resin wall 41 is formed along the outer edge of the first opening 94 on the upper surface of the first insulating layer 31 by photolithography. In this process, the lower resin wall 41 is formed at positions slightly away from the opening edge of the first opening 94.

Next, as illustrated in FIG. 12, the lower inductor wiring line forming step S16 is performed. In the lower inductor wiring line forming step S16, the lower inductor wiring line 51L is formed by electrolytic plating by supplying electric current to the seed layer 93. More specifically, the lower wiring main portion 52L is formed in the space surrounded by the lower resin wall 41, and the lower protruding portion 53L protruding from the lower wiring main portion 52L and extending along the lower wiring main portion 52L is integrally formed in the first opening 94. In the lower inductor wiring line forming step S16, since the lower inductor wiring line 51L is formed in a single electrolytic plating process, the lower wiring main portion 52L and the lower protruding portion 53L are integrally formed.

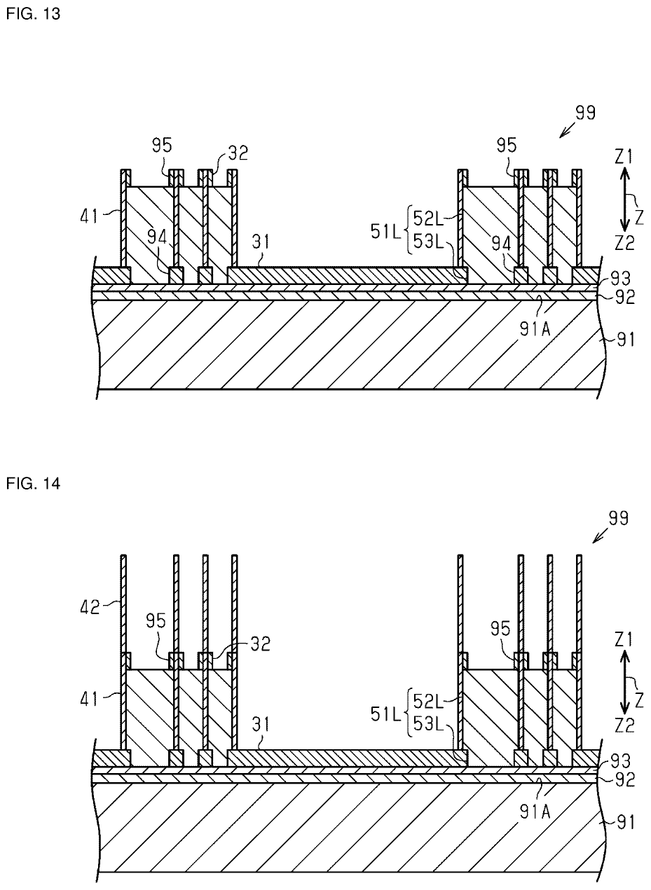

Next, as illustrated in FIG. 13, the second insulating layer forming step S17 is performed. In the second insulating layer forming step S17, the second insulating layer 32 having a second opening 95 corresponding to a specified wiring pattern is formed on the upper surface of the lower wiring main portion 52L by photolithography. The position and shape of the second opening 95 correspond to the position and shape of the upper protruding portion 53U of the upper inductor wiring line 51U to be formed in a later step. The region of the second opening 95 is slightly smaller than the region where the upper wiring main portion 52U is to be formed. Hence, the “specified wiring pattern” in the second insulating layer forming step S17 refers to the position and shape along the upper inductor wiring line 51U to be formed in the upper inductor wiring line forming step S19.

Note that the dimensions of the second opening 95 are the same as the dimensions of the first opening 94 in the directions parallel to the main surface 91A. In other words, when viewed in the third negative direction Z2, the outer edge shape of the second opening 95 is the same as the outer edge shape of the first opening 94. Note that the term “the same” allows, for example, manufacturing deviations of 5%.

Next, as illustrated in FIG. 14, the upper resin wall forming step S18 is performed. In the upper resin wall forming step S18, the upper resin wall 42 is formed along the outer edge of the second opening 95 on the upper surface of the second insulating layer 32 by photolithography. In this process, the upper resin wall 42 is formed at positions slightly away from the opening edge of the second opening 95.

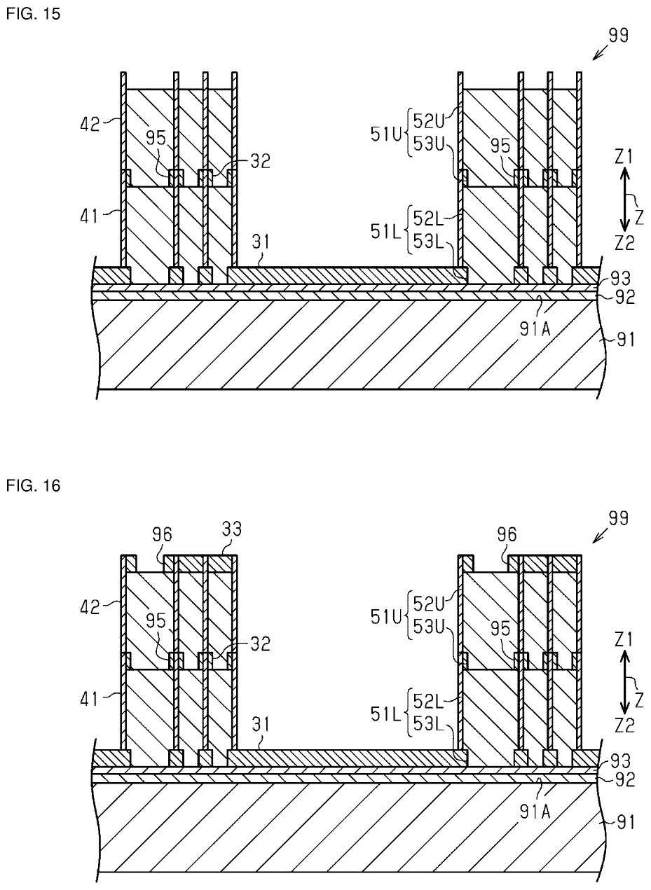

Next, as illustrated in FIG. 15, the upper inductor wiring line forming step S19 is performed. In the upper inductor wiring line forming step S19, the upper inductor wiring line 51U is formed by electrolytic plating by supplying electric current to the seed layer 93. More specifically, the upper wiring main portion 52U is formed in the space surrounded by the upper resin wall 42, and the upper protruding portion 53U protruding from the upper wiring main portion 52U and extending along the upper wiring main portion 52U is integrally formed in the second opening 95. In the upper inductor wiring line forming step S19, since the upper inductor wiring line 51U is formed in a single electrolytic plating process, the upper wiring main portion 52U and the upper protruding portion 53U are integrally formed.

Next, as illustrated in FIG. 16, the third insulating layer forming step S20 is performed. In the third insulating layer forming step S20, the third insulating layer 33 having third openings 96 corresponding to a specified pattern is formed on the upper surface of the upper wiring main portion 52U by photolithography. The positions and shapes of the third openings 96 correspond to the positions and shapes of the first extended portion 63A and the second extended portion 63B to be formed later. In this case, the region of each third openings 96 is slightly smaller than the region in which the corresponding columnar portion is to be formed.

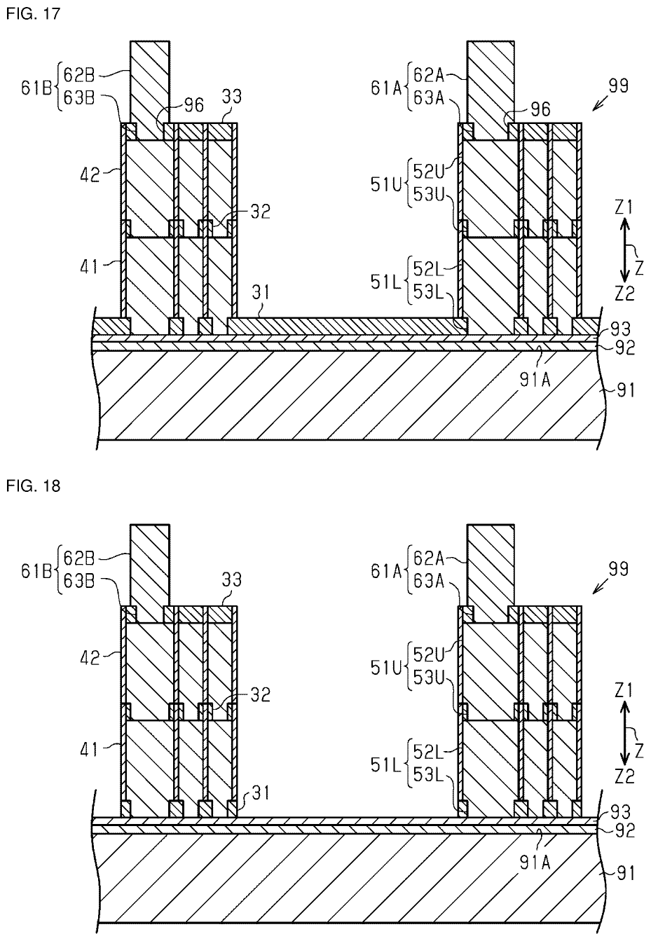

Next, as illustrated in FIG. 17, the columnar wiring line forming step S21 is performed. In the columnar wiring line forming step S21, by supplying electric current to the seed layer 93, the extended portions are formed in the third openings 96, and the columnar portions are integrally formed on the third positive direction Z1 side of the extended portions and the third insulating layer 33 by electrolytic plating through the inductor wiring line 50.

Specifically, although illustration is omitted, supplemental walls composed of a resin are formed by photolithography along the outer edges of the third openings 96 on the upper surface of the third insulating layer 33. In this process, the supplemental walls are formed at positions slightly away from the opening edges of the third openings 96. Next, the columnar portions are formed by electrolytic plating in the spaces surrounded by the supplemental walls. In the same process, the first extended portion 63A protruding from the first columnar portion 62A is integrally formed in a third opening 96, and the second extended portion 63B protruding from the second columnar portion 62B is integrally formed. Then, by removing the supplemental walls, the columnar wiring lines are formed.

Next, as illustrated in FIG. 18, the insulating layer cutting step S22 is performed. In the insulating layer cutting step S22, surplus portions of the first insulating layer 31 are removed by laser. Specifically, in the first insulating layer 31, the portions not overlapping the region in which the inductor wiring line 50 and the resin walls are present when viewed in the direction orthogonal to the main surface 91A of the base substrate 91 are cut so that the seed layer 93 is exposed.

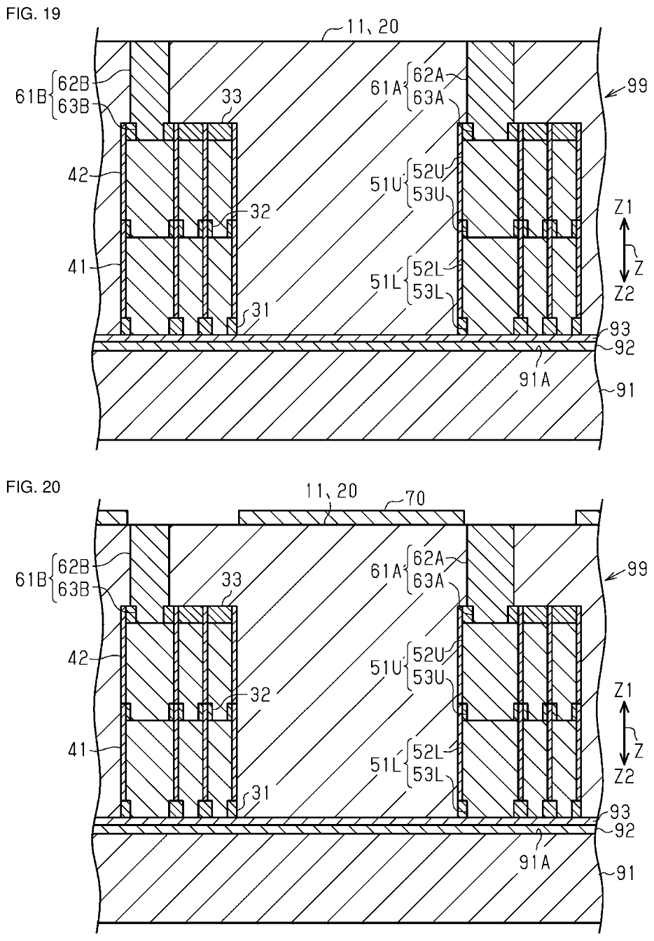

Next, as illustrated in FIG. 19, the first element body forming step S23 is performed. In the first element body forming step S23, the magnetic layer 20 containing a magnetic material is formed around the lower wiring main portion 52L, the lower protruding portion 53L, the upper wiring main portion 52U, the upper protruding portion 53U, the extended portions, and the columnar portions. Specifically, the magnetic layer 20 excluding the first magnetic layer 21 is formed around the first insulating layer 31 covering the lower protruding portion 53L, the lower resin wall 41 covering the lower wiring main portion 52L, the second insulating layer 32 covering the upper protruding portion 53U, the upper resin wall 42 covering the upper wiring main portion 52U, the third insulating layer 33 covering the two extended portions, and the two columnar portions.

More specifically, in the first element body forming step S23, first, a resin containing magnetic powder is applied onto the upper surface of the seed layer 93. In this process, the resin containing magnetic powder is applied so as to also cover the upper surfaces of the columnar wiring lines. Next, the resin containing magnetic powder is compacted by a pressing process. Thereafter, a portion of the resin on the upper surface side is removed until the upper surfaces of the columnar wiring lines are exposed. With this process, the first interlayer magnetic layer 22, the second magnetic layer 23, the second interlayer magnetic layer 24, the third magnetic layer 25, the third interlayer magnetic layer 26, and the fourth magnetic layer 27 are formed on the upper surface of the seed layer 93. Note that in FIGS. 19 to 24, the first interlayer magnetic layer 22, the second magnetic layer 23, the second interlayer magnetic layer 24, the third magnetic layer 25, the third interlayer magnetic layer 26, and the fourth magnetic layer 27 are illustrated as the magnetic layer 20 without indicating their boundaries.

Next, as illustrated in FIG. 20, the solder resist forming step S24 is performed. In the solder resist forming step S24, the solder resist 70 is formed in the region in which the first outer electrode 81A and the second outer electrode 81B are not to be formed, on the upper surface of the third magnetic layer 25 and the upper surfaces of the columnar wiring lines. Specifically, an insulating resin is patterned in the region mentioned above by photolithography.

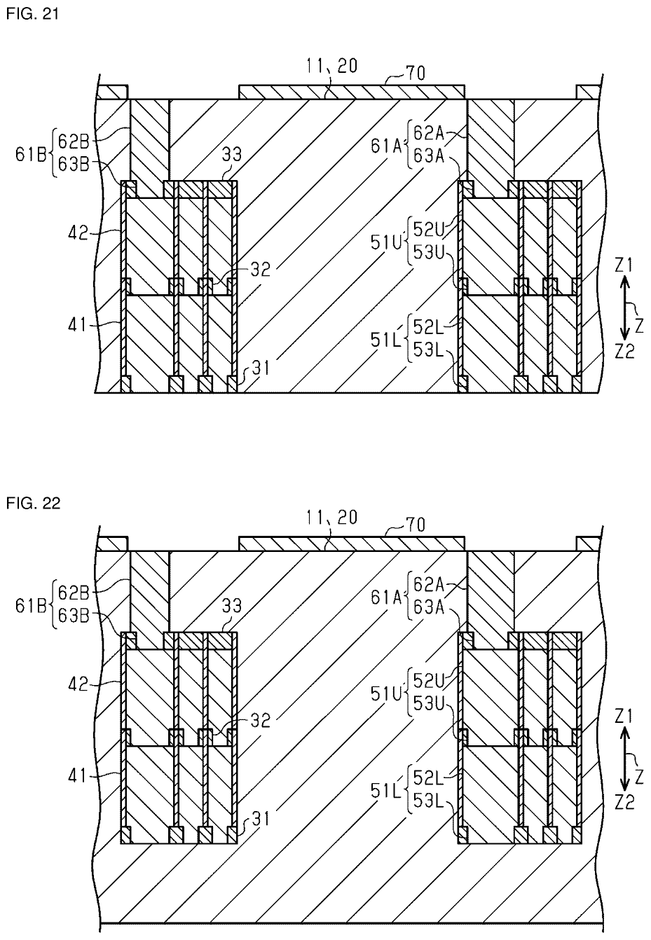

Next, as illustrated in FIG. 21, the seed layer removing step S25 is performed. In the seed layer removing step S25, first, the base substrate 91 is removed by cutting. Next, the adhesive layer 92 is removed by a method such as desmear treatment or ashing. Thereafter, the seed layer 93 is removed by etching. Note that the structure in the period from the upper inductor wiring line forming step S19 until the base substrate 91 is removed in the seed layer removing step S25 can be treated as a substrate 99 for manufacturing the inductor component.

Next, as illustrated in FIG. 22, the second element body forming step S26 is performed. In the second element body forming step S26, the first magnetic layer 21 containing a magnetic material is formed on the lower surfaces of the first insulating layer 31 and the first interlayer magnetic layer 22. Specifically, in the second element body forming step S26, first, a resin containing magnetic powder is applied onto the lower surfaces of the first insulating layer 31 and the first interlayer magnetic layer 22. Then, the resin containing magnetic powder is compacted by a pressing process. Thereafter, the lower surface side of the resin mentioned above is removed so that the dimensions of the inductor component 10 are desired values. Thus, the first magnetic layer 21 is formed on the surfaces of the first insulating layer 31 and the first interlayer magnetic layer 22 on the third negative direction Z2 side. Note that in FIGS. 22 to 24, the first magnetic layer 21, the first interlayer magnetic layer 22, the second magnetic layer 23, the second interlayer magnetic layer 24, the third magnetic layer 25, the third interlayer magnetic layer 26, and the fourth magnetic layer 27 are illustrated as the magnetic layer 20 without indicating their boundaries.

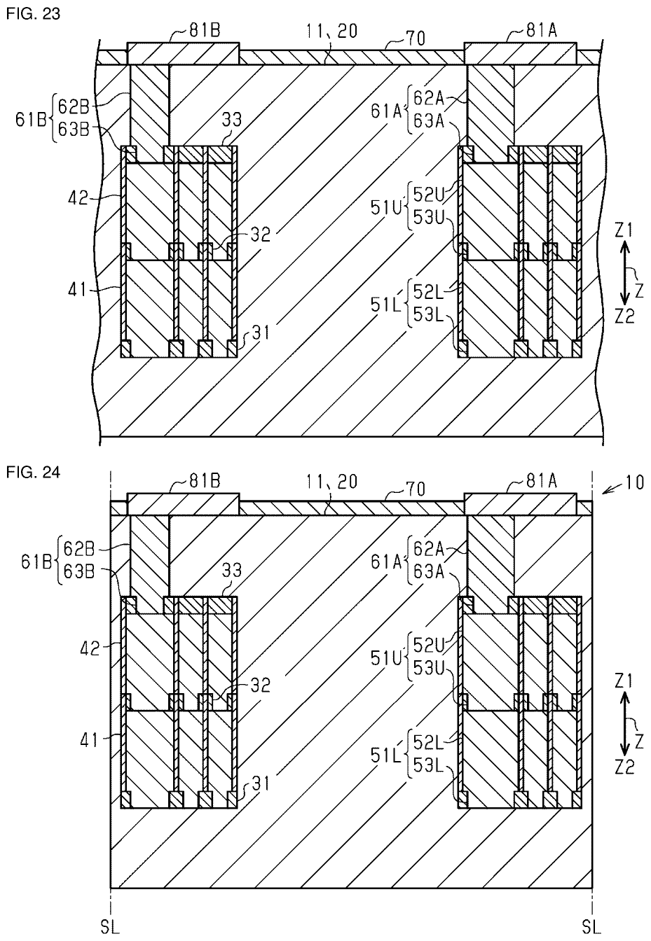

Next, as illustrated in FIG. 23, the outer electrode forming step S27 is performed. In the outer electrode forming step S27, the first outer electrode 81A and the second outer electrode 81B are formed. The regions in which the outer electrodes are to be formed are the regions on the upper surface of the fourth magnetic layer 27 and the upper surfaces of the columnar wiring lines that are not covered by the solder resist 70. In the regions mentioned above, copper plating, nickel plating, and gold plating are performed in this order by electroless plating. Thus, the first outer electrode 81A and the second outer electrode 81B are formed in the regions mentioned above. Note that in FIGS. 23 and 24, the copper plating layer, the nickel plating layer, and the gold plating layer are illustrated without indicating their boundaries.

Next, as illustrated in FIG. 24, the singulation step S28 is performed. In the singulation step S28, the inductor components 10 are separated into individual pieces with a dicing machine. Specifically, the plurality of inductor components 10 integrally formed are separated into individual inductor components 10. In FIG. 24, cutting surfaces SL of the inductor component 10 by cutting with a dicing machine are indicated by dashed dotted lines. Through the steps described above, the inductor component 10 is manufactured.

### Effects of First Embodiment

(1-1) In the embodiment described above, the inductor wiring line 50 includes the lower inductor wiring line 51L and the upper inductor wiring line 51U. Thus, the cross-sectional area of the inductor wiring line 50 is larger than, for example, in a configuration with only the lower inductor wiring line 51L by the area corresponding to the upper inductor wiring line 51U. Accordingly, the DC resistance of the inductor wiring line 50 can be reduced. In addition, since the inductor wiring line 50 is large in the height direction, the distance between parallel portions in the inductor wiring line 50 is less likely to become smaller than in a configuration in which the size of the inductor wiring line 50 is increased in the width direction. In other words, a short circuit is less likely to occur between different portions of the inductor wiring line 50.

In addition, the lower inductor wiring line 51L includes the lower wiring main portion 52L and the lower protruding portion 53L. The lower protruding portion 53L extends to a position where the first insulating layer 31 is present in the direction orthogonal to the first main surface 11A. This increases the cross-sectional area of the lower inductor wiring line 51L by the area corresponding to the lower protruding portion 53L. Accordingly, the DC resistance of the lower inductor wiring line 51L can be reduced.

The lower protruding portion 53L protrudes from the outer surface of the lower wiring main portion 52L on the third negative direction Z2 side and extends along the lower wiring main portion 52L. In other words, the lower protruding portion 53L is present within the region of the outer surface of the lower wiring main portion 52L on the third negative direction Z2 side.
(1-2) The outer surface of the lower protruding portion 53L on the third negative direction Z2 side is in contact with the element body 11 and hence is not in contact with other conductive members. Thus, the possibility that a short circuit occurs between different portions of the lower protruding portion 53L is low.
(1-3) In the embodiment described above, the total height dimension 50H of the inductor wiring line 50 is at least twice the minimum width dimension 52LW of the lower wiring main portion 52L. The total height dimension 50H of the inductor wiring line 50 is at least twice the minimum width dimension 52UW of the upper wiring main portion 52U. In the case where the total height dimension 50H of the inductor wiring line 50 is at least twice the minimum width dimension of each wiring main portion, the DC resistance is reduced.
(1-4) In the embodiment described above, the lower wiring main portion 52L and the lower protruding portion 53L are formed as an integral structure. This prevents disturbance of the electric field that would otherwise occur at the boundary surface between the lower wiring main portion 52L and the lower protruding portion 53L. Specifically, the DC resistance can be reduced as compared with a configuration in which a distinct boundary surface is present between the lower wiring main portion 52L and the lower protruding portion 53L.
(1-5) In the embodiment described above, the inductor wiring line 50 or a conductive member is not exposed on the side surfaces 11C of the element body 11. Specifically, for example, no power-supply wiring used for electrolytic plating to form the inductor wiring line 50 is exposed. Hence, there is no possibility that corrosion of a conductive member exposed on a side surface 11C of the element body 11 will extend to the inductor wiring line 50 in the element body 11.
(1-6) In the embodiment described above, the side surface 53LS of the lower protruding portion 53L is covered with the first insulating layer 31. This further increases the insulation between different portions of the lower protruding portion 53L.
(1-7) In the embodiment described above, the inductor component 10 includes the first columnar wiring line 61A and the second columnar wiring line 61B. This enables the inductor wiring line 50 to be electrically connected on the first main surface 11A or the second main surface 11B of the element body 11 to an external electronic substrate or the like.
(1-8) In the embodiment described above, the upper inductor wiring line 51U is in contact with the first columnar wiring line 61A. The number of boundary surfaces between the upper inductor wiring line 51U and the first columnar wiring line 61A is less than in a configuration in which other metal layers are interposed between the upper inductor wiring line 51U and the first columnar wiring line 61A. This prevents an increase in the electric resistance between the upper inductor wiring line 51U and the first columnar wiring line 61A. In this regard, the same applies to the second columnar wiring line 61B.
(1-9) In the embodiment described above, the upper inductor wiring line 51U includes the upper protruding portion 53U. Then, the side surface 53US of the upper protruding portion 53U is covered with the second insulating layer 32. This increases the insulation between different portions of the upper protruding portion 53U.
(1-10) In the embodiment described above, the upper wiring main portion 52U and the upper protruding portion 53U are formed as an integral structure. This configuration prevents disturbance of the electric field that would otherwise occur at the boundary surface between the upper wiring main portion 52U and the upper protruding portion 53U. Specifically, the DC resistance can be reduced as compared with a configuration in which a distinct boundary surface is present between the upper wiring main portion 52U and the upper protruding portion 53U.
(1-11) In the embodiment described above, the lower resin wall 41 is in contact with the side surface 32S of the second insulating layer 32. This further increases the insulation different portions of the inductor wiring line 50 in the vicinity of the contact portion between the lower inductor wiring line 51L and the upper inductor wiring line 51U.
(1-12) In the embodiment described above, when the lower inductor wiring line 51L is formed, the wiring pattern is formed by using the first insulating layer 31. Thus, even in the case where the lower inductor wiring line 51L is formed such that the distance between different portions thereof is short, the possibility that a short circuit occurs between the different portions is low. Accordingly, the small space in the element body 11 can be used more effectively than in a case where the wiring pattern is formed by using a seed layer.

The inductor wiring line 50 is formed in the upper inductor wiring line forming step S19 and the lower inductor wiring line forming step S16. Thus, the occurrence of manufacturing deviations can be reduced, compared with a case where an inductor wiring line 50 having a large height dimension is formed in a single electrolytic plating process.
(1-13) In the embodiment described above, when the upper inductor wiring line 51U is formed, the second insulating layer 32 is formed. This reduces the possibility that a short circuit occurs between different portions of the upper inductor wiring line 51U due to manufacturing deviations or the like. In other words, this increases the insulation between different portions of the upper inductor wiring line 51U.
(1-14) In the embodiment described above, the substrate 99 for manufacturing the inductor components includes the base substrate 91. Hence, the base substrate 91 can be held for handling during the manufacturing process of the inductor component 10. For example, this reduces the possibility that the inductor components 10 are scratched, compared with a case where the element bodies 11 are directly held for handling.
(1-15) In the embodiment described above, the substrate 99 for manufacturing the inductor component includes the adhesive layer 92. This makes it easy to separate the seed layer 93 and the base substrate 91, compared with a case where the base substrate 91 is cut. Thus, the manufacturing effort required for the inductor component 10 can be reduced.
(1-16) In the embodiment described above, the inductor wiring line 50 has a spiral shape, and the number of turns of the inductor wiring line 50 is greater than one turn. In other words, the inductor wiring line 50 has different portions extending in parallel. Even in this case, since the inductor wiring line 50 includes the lower protruding portion 53L, a sufficient cross-sectional area of the inductor wiring line 50 can be ensured without increasing the width of the inductor wiring line 50. In other words, it is easy to prevent a short circuit between the parallel portions of the inductor wiring line 50 while a sufficient cross-sectional area of the inductor wiring line 50 is ensured.
(1-17) In the embodiment described above, each columnar wiring line includes the columnar portion and the extended portion. Each columnar portion is connected to the inductor wiring line 50 with the corresponding extended portion, which has an integral structure with the columnar portion, interposed therebetween. In other words, no other conductive portion, such as the seed layer 93, is interposed between each columnar wiring line and the inductor wiring line 50. Hence, the manufacturing steps for the inductor component 10 can be simplified, compared with a case where another conductive portion is interposed between each columnar wiring line and the inductor wiring line 50.
(1-18) In the embodiment described above, in a transparent view in the third positive direction Z1, the outer edge of the first extended portion 63A is parallel to the outer edge of the first columnar portion 62A. In addition, the outer edge of the first extended portion 63A is parallel to the outer edge of the upper-inner pad portion UP1. This simplifies the structure, compared with a case where these outer edges are not parallel to one another. In this regard, the same applies to the outer edge of the second columnar wiring line 61B and the outer edge of the upper-outer pad portion UP2.
(1-19) In the embodiment described above, in a transparent view in the third positive direction Z1, the area of the region surrounded by the outer edge of the first columnar portion 62A is smaller than or equal to 1.3 times the area of the region surrounded by the outer edge of the first extended portion 63A. With such a small difference in area, it is highly likely that the columnar portion can be formed as designed by supplying electric current via the inductor wiring line 50 without a conductive member, such as the seed layer 93, interposed therebetween. In this regard, the same applies to the second columnar portion 62B and the second extended portion 63B.
(1-20) In the embodiment described above, each extended portion is covered with the third insulating layer 33. This increases the insulation between each extended portion and the element body 11.
(1-21) In the embodiment described above, each columnar portion and the corresponding extended portion are integrally formed in the columnar wiring line forming step S21. In other words, during the manufacturing process of the inductor component 10, no other conductive portion such as the seed layer 93 is not interposed between each columnar wiring line and the inductor wiring line 50. Hence, the manufacturing steps for the inductor component 10 can be simplified, compared with a case where another conductive portion is interposed between each columnar wiring line and the inductor wiring line 50.

### Inductor Component of Second Embodiment

The following describes an inductor component and a method of manufacturing an inductor component according to the second embodiment.

### Overall Configuration

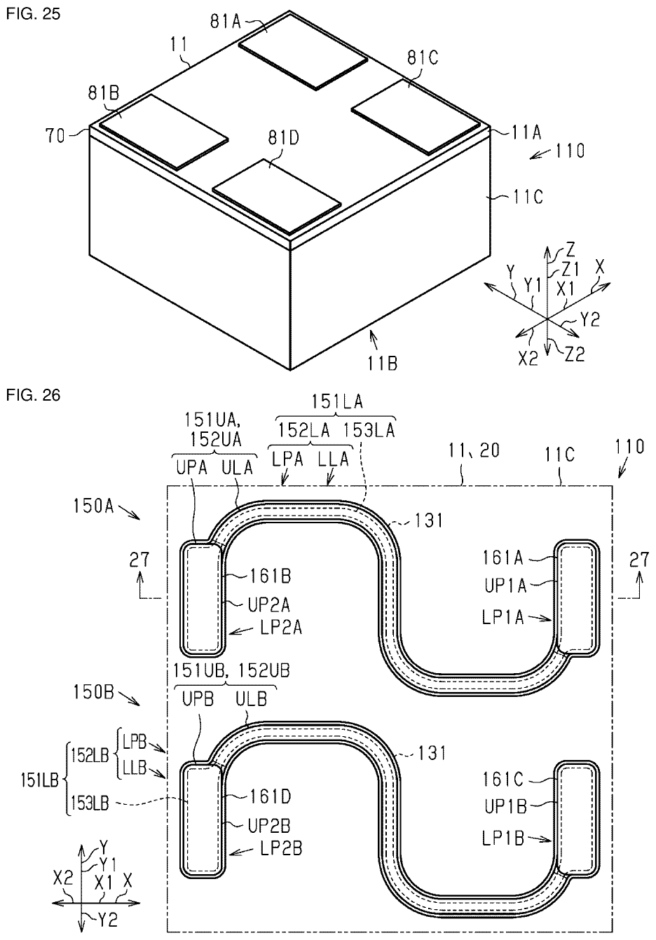

As illustrated in FIGS. 25 and 26, an inductor component 110 according to the second embodiment is different from that of the first embodiment mainly in that the inductor component 110 includes a second inductor wiring line 150B and a first to fourth outer electrodes 81A to 81D, and that the element body 11 does not include the second interlayer magnetic layer 24 and the third interlayer magnetic layer 26. Since the element body 11 does not include the second interlayer magnetic layer 24, the inductor component 110 does not include the second insulating layer 32. In addition, upper inductor wiring lines do not include upper protruding portions. In other words, each upper inductor wiring line in the second embodiment only includes an upper wiring main portion. Since the element body 11 does not include the third interlayer magnetic layer 26, the inductor component 110 does not include the second insulating layer 32. In addition, each columnar wiring line does not include an extended portion. In the following description, the structural elements the same as or similar to those in the first embodiment are denoted by the same reference signs, and description thereof is omitted or simplified.

As illustrated in FIG. 25, of the outer surfaces of the element body 11, the outer shape of the first main surface 11A and the outer shape of the second main surface 11B are approximately square.

As illustrated in FIG. 26, the inductor component 110 includes a first insulating layer 131. In a transparent view of the inductor component 110 from the third positive direction Z1, the first insulating layer 131 extends along a plane parallel to the first main surface 11A in the element body 11. The first insulating layer 131 is in contact with the surface of the first magnetic layer 21 on the third positive direction Z1 side. In the third axis Z direction, the position of the first insulating layer 131 is the same as that of the first interlayer magnetic layer 22. In this embodiment, the inductor component 110 includes the first inductor wiring line 150A and the second inductor wiring line 150B, and the first insulating layer 131 is present in two separate locations corresponding to these wiring lines.

The inductor component 110 includes two inductor wiring lines. Specifically, the inductor component 110 includes the first inductor wiring line 150A and the second inductor wiring line 150B. The first inductor wiring line 150A and the second inductor wiring line 150B are located in the same layers in the third axis Z direction. In a transparent view of the inductor component 110 from the third positive direction Z1, each of the first inductor wiring line 150A and the second inductor wiring line 150B extends in an S shape.

In the following, in the first inductor wiring line 150A, the lower inductor wiring line is referred to as the first lower inductor wiring line 151LA, the lower wiring portion as the first lower wiring portion LLA, the two lower pad portions as the first lower pad portions LPA, the lower wiring main portion as the first lower wiring main portion 152LA, and the lower protruding portion as the first lower protruding portion 153LA. The first lower pad portion LPA located on the first positive direction X1 side is referred to as the first-end lower pad portion LP1A, and the first lower pad portion LPA located on the first negative direction X2 side as the second-end lower pad portion LP2A.

In the first inductor wiring line 150A, the upper inductor wiring line is referred to as the first upper inductor wiring line 151UA, the upper wiring portion as the first upper wiring portion ULA, the two upper pad portions as the first upper pad portions UPA, and the upper wiring main portion as the first upper wiring main portion 152UA. The first upper pad portion UPA located on the first positive direction X1 side is referred to as the first-end upper pad portion UP1A, and the first upper pad portion UPA located on the first negative direction X2 side as the second-end upper pad portion UP2A.

In the following, in the second inductor wiring line 150B, the lower inductor wiring line is referred to as the second lower inductor wiring line 151 LB, the lower wiring portion as the second lower wiring portion LLB, the two lower pad portions as the second lower pad portions LPB, the lower wiring main portion as the second lower wiring main portion 152 LB, and the lower protruding portion as the second lower protruding portion 153 LB. The second lower pad portion LPB located on the first positive direction X1 side is referred to as the first-end lower pad portion LP1B, and the second lower pad portion LPB located on the first negative direction X2 side as the second-end lower pad portion LP2B.

In the second inductor wiring line 150B, the upper inductor wiring line is referred to as the second upper inductor wiring line 151UB, the upper wiring portion as the second upper wiring portion ULB, the two upper pad portions as the second upper pad portions UPB, and the upper wiring main portion as the second upper wiring main portion 152UB. The second upper pad portion UPB located on the first positive direction X1 side is referred to as the first-end upper pad portion UP1B, and the second upper pad portion UPB located on the first negative direction X2 side as the second-end upper pad portion UP2B.

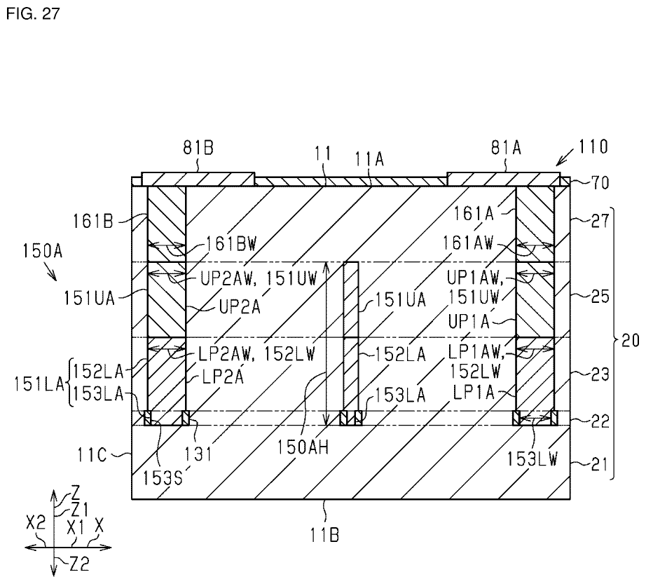

As illustrated in FIG. 27, the outer surface of the first upper inductor wiring line 151UA on the third positive direction Z1 side is in contact with the outer surface of the fourth magnetic layer 27 on the third negative direction Z2 side and the outer surfaces of the columnar wiring lines on the third negative direction Z2 side. Although illustration is omitted, the outer surface of the second upper inductor wiring line 151UB on the third positive direction Z1 side is in contact with the outer surface of the fourth magnetic layer 27 on the third negative direction Z2 side and the outer surfaces of the columnar wiring lines on the third negative direction Z2 side.

The maximum width dimension 151UW of the first upper inductor wiring line 151UA is within a range from −20% to +20%, inclusive, relative to the maximum width dimension 152LW of the first lower wiring main portion 152LA. The maximum width dimension 152LW of the first lower wiring main portion 152LA refers to the maximum dimension of the first lower wiring main portion 152LA in the direction orthogonal to the center line of the first lower inductor wiring line 151LA and parallel to the first main surface 11A. The maximum width dimension 151UW of the first upper inductor wiring line 151UA refers to the maximum dimension of the first upper inductor wiring line 151UA in the direction orthogonal to the center line of the first upper inductor wiring line 151UA and parallel to the first main surface 11A.

The first lower protruding portion 153LA of the first inductor wiring line 150A has the same configuration as the lower protruding portion 53L of the inductor component 10 according to the first embodiment. Specifically, as illustrated in FIG. 27, the outer surface of the first lower protruding portion 153LA on the third negative direction Z2 side is in contact with the element body 11. The side surface 153S of the first lower protruding portion 153LA is in contact with the first insulating layer 131. Note that the side surface 153S of the first lower protruding portion 153LA refers to the outer surfaces of the first lower protruding portion 153LA other than the outer surface on the third negative direction Z2 side. In this case, since the first lower protruding portion 153LA protrudes form the first lower wiring main portion 152LA, the first lower protruding portion 153LA does not have an outer surface on the third positive direction Z1 side.

In a transparent view in the third positive direction Z1, the first lower protruding portion 153LA extends along the first lower wiring main portion 152LA. Specifically, the first lower protruding portion 153LA extends from the first-end lower pad portion LP1A via the first lower wiring portion LLA to the second-end lower pad portion LP2A. In other words, the first lower protruding portion 153LA extends along approximately the entire region of the first lower wiring main portion 152LA.

As illustrated in FIG. 26, in a transparent view in the third positive direction Z1, the first lower protruding portion 153LA is located within the region surrounded by the outer edge of the first lower wiring main portion 152LA. More specifically, as illustrated in FIG. 27, in a cross-sectional view taken along a cross section orthogonal to the first main surface 11A, the dimension of each portion of the first lower inductor wiring line 151LA in the direction parallel to the first main surface 11A is defined as its width dimension. The width dimension 153LW of the first lower protruding portion 153LA is smaller than the width dimension of the first lower wiring main portion 152LA at the position where the first lower protruding portion 153LA is connected in the same cross section. Note that in FIG. 27, the width dimension of the first lower wiring main portion 152LA is the maximum width dimension 152LW. In other words, the width dimension 153LW of the first lower protruding portion 153LA is smaller than the maximum width dimension 152LW of the first lower wiring main portion 152LA at the position where the first lower protruding portion 153LA is connected in the same cross section.

As illustrated in FIG. 26, the inductor component 110 includes four columnar wiring lines. Specifically, the inductor component 110 includes a first columnar wiring line 161A, a second columnar wiring line 161B, a third columnar wiring line 161C, and a fourth columnar wiring line 161D. The shape of each columnar wiring line is an approximately rectangular column corresponding to the shape of the upper pad portion to which the columnar wiring line is connected.

In the present embodiment, in a transparent view of the inductor component 110 in the third negative direction Z2, the outer edge of each columnar wiring line is approximately aligned with the outer edge of the corresponding pad portion. Accordingly, the area of the region surrounded by the outer edge of each columnar wiring line is the same as the area of the region surrounded by the outer edge of the pad portion to which the columnar wiring line is connected. The expression “the area is the same” allows, for example, manufacturing deviations of 5%.

As illustrated in FIG. 27, each columnar wiring line is located in the same layer as the third magnetic layer 25 in the third axis Z direction.

One end of the first columnar wiring line 161A is in contact with the surface, parallel to the first main surface 11A, of the first-end upper pad portion UP1A of the first upper pad portions UPA. In this embodiment, the difference between the dimension UP1AW of the first-end upper pad portion UP1A in the direction parallel to the first main surface 11A and the dimension 161AW of the first columnar wiring line 161A in the direction parallel to the first main surface 11A is approximately zero.

The difference between the dimension UP1AW of the first-end upper pad portion UP1A in the direction parallel to the first main surface 11A and the dimension LP1AW of the first-end lower pad portion LP1A in the direction parallel to the first main surface 11A is approximately zero. Hence, the difference between the dimension LP1AW of the first-end lower pad portion LP1A in the direction parallel to the first main surface 11A and the dimension 161AW of the first columnar wiring line 161A in the direction parallel to the first main surface 11A is also approximately zero.

One end of the second columnar wiring line 161B is in contact with the surface, parallel to the first main surface 11A, of the second-end upper pad portion UP2A of the first upper pad portions UPA. In this embodiment, the difference between the dimension UP2AW of the second-end upper pad portion UP2A in the direction parallel to the first main surface 11A and the dimension 161BW of the second columnar wiring line 161B in the direction parallel to the first main surface 11A is approximately zero.

The difference between the dimension UP2AW of the second-end upper pad portion UP2A in the direction parallel to the first main surface 11A and the dimension LP2AW of the second-end lower pad portion LP2A in the direction parallel to the first main surface 11A is approximately zero. Hence, the difference between the dimension LP2AW of the second-end lower pad portion LP2A in the direction parallel to the first main surface 11A and the dimension 161BW of the second columnar wiring line 161B in the direction parallel to the first main surface 11A is also approximately zero.

One end of the second columnar wiring line 161B is in contact with the surface, parallel to the first main surface 11A, of the second-end upper pad portion UP2A of the first upper pad portions UPA. In this embodiment, the difference between the dimension UP2AW of the second-end upper pad portion UP2A in the direction parallel to the first main surface 11A and the dimension 161BW of the second columnar wiring line 161B in the direction parallel to the first main surface 11A is approximately zero.

Although illustration is omitted, in this regard, the same applies to the third columnar wiring line 161C and the fourth columnar wiring line 161D. In the present embodiment, in a cross-sectional view taken along a cross section orthogonal to the first main surface 11A, the dimension of each upper pad portion, the dimension of the columnar wiring line to which the upper pad portion is connected, and the dimension of the lower pad portion located in the third negative direction Z2 relative to the upper pad portion are the same in the direction parallel to the first main surface 11A. The expression that the dimensions are “the same” allows, for example, manufacturing deviations of 5%.

As illustrated in FIG. 25, the inductor component 110 includes the four outer electrodes. The four outer electrodes are the first outer electrode 81A, the second outer electrode 81B, the third outer electrode 81C, and the fourth outer electrode 81D.

The first outer electrode 81A is located in the first positive direction X1 and in the second positive direction Y1 relative to the geometric center of the first main surface 11A on the first main surface 11A. The second outer electrode 81B is located in the first negative direction X2 and in the second positive direction Y1 relative to the above-mentioned geometric center on the first main surface 11A. The third outer electrode 81C is located in the first positive direction X1 and in the second negative direction Y2 relative to the above-mentioned geometric center on the first main surface 11A. The fourth outer electrode 81D is located in the first negative direction X2 and in the second negative direction Y2 relative to the above-mentioned geometric center on the first main surface 11A.

The first outer electrode 81A is in contact with the surface of the first columnar wiring line 161A facing the third positive direction Z1. The second outer electrode 81B is in contact with the surface of the second columnar wiring line 161B facing the third positive direction Z1. The third outer electrode 81C is in contact with the surface of the third columnar wiring line 161C facing the third positive direction Z1. The fourth outer electrode 81D is in contact with the surface of the fourth columnar wiring line 161D facing the third positive direction Z1.

### Manufacturing Method

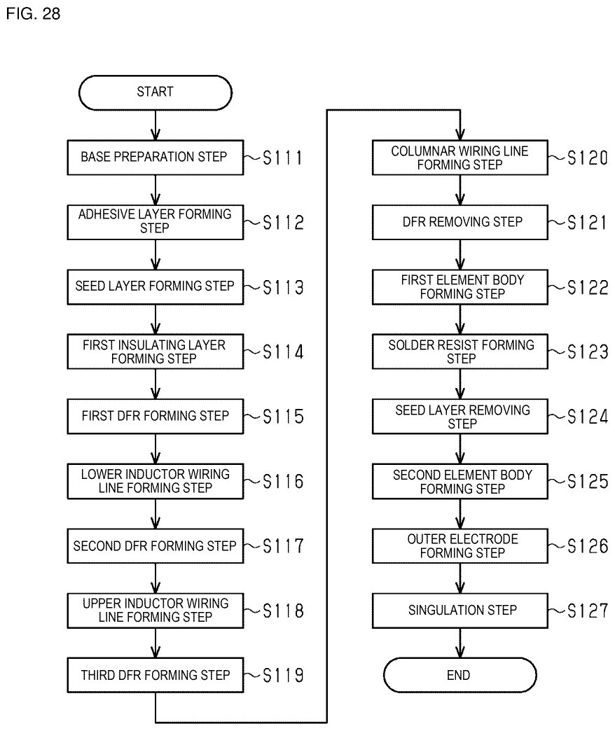

As illustrated in FIG. 28, a method of manufacturing the inductor component 110 according to the second embodiment is different from the manufacturing method of the first embodiment mainly in that the manufacturing method of the second embodiment does not include the lower resin wall forming step S15, the second insulating layer forming step S17, the upper resin wall forming step S18, the third insulating layer forming step S20, and the insulating layer cutting step S22. In addition, the method of manufacturing the inductor component 110 according to the second embodiment is different from the manufacturing method of the first embodiment in that the manufacturing method of the second embodiment includes a first DFR forming step S115, a second DFR forming step S117, a third DFR forming step S119, and a DFR removing step S121.

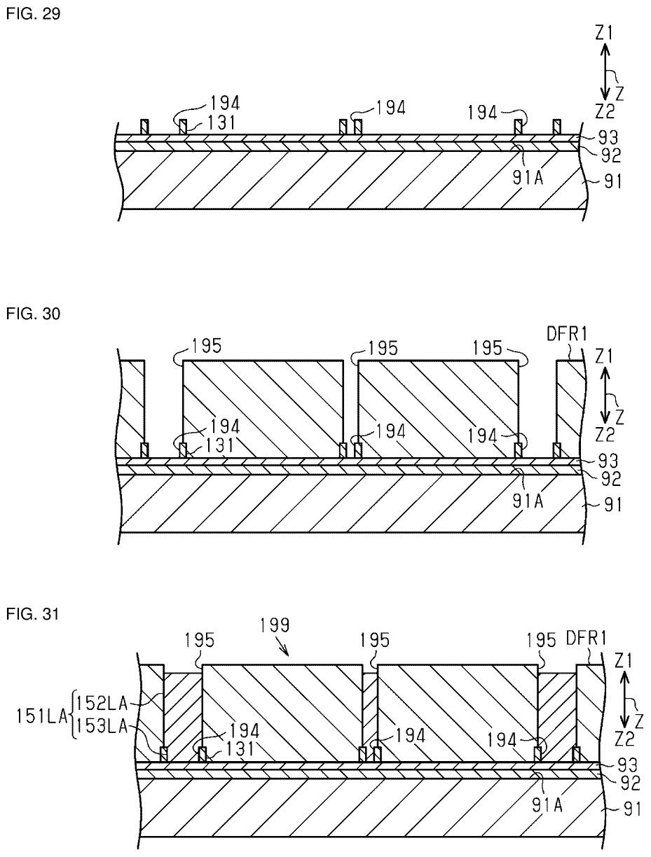

FIGS. 29 to 36 only illustrate diagrams corresponding to the cross-sectional view of the inductor component 110 in FIG. 27. Specifically, FIGS. 29 to 36 illustrate only a cross section passing through the first inductor wiring line 150A, the first columnar wiring line 161A, and the second columnar wiring line 161B, and the same applies to a cross section passing through the second inductor wiring line 150B, the third columnar wiring line 161C, and the fourth columnar wiring line 161D.

First, in the second embodiment, the process from the base preparation step S111 to the first insulating layer forming step S114 is performed in methods the same as or similar to those of the first embodiment. Specifically, as illustrated in FIG. 29, after the first insulating layer forming step S114 in the second embodiment, an adhesive layer 92 is present on the upper surface of the base substrate 91. A seed layer 93 is formed on the upper surface of the adhesive layer 92. In this process, the seed layer 93 is formed on the entire main surface 91A of the base substrate 91. The first insulating layer 131 is formed in two separate locations on the upper surface of the seed layer 93. The positions and shapes of first openings 194 in the first insulating layer 131 correspond to the positions and shapes of the first lower protruding portion 153LA of the first lower inductor wiring line 151LA and the second lower protruding portion 153LB of the second lower inductor wiring line 151LB to be formed in a later step.

Next, as illustrated in FIG. 30, the first DFR forming step S115 is performed. In the first DFR forming step S115, a first dry film resist DFR1 having two second openings 195 is formed by photolithography on the upper surfaces of the seed layer 93 and the first insulating layer 131. The two second openings 195 have specified patterns. Specifically, the position and shape of one of the second openings 195 correspond to the position and shape of the first lower wiring main portion 152LA to be formed later. The position and shape of the other of the second openings 195 correspond to the position and shape of the second lower wiring main portion 152LB to be formed later.

Next, as illustrated in FIG. 31, the lower inductor wiring line forming step S116 is performed. In the lower inductor wiring line forming step S116, the lower inductor wiring lines are formed by electrolytic plating by supplying electric current to the seed layer 93. Specifically, the first lower wiring main portion 152LA is formed in one of the second openings 195 of the first dry film resist DFR1, and the first lower protruding portion 153LA protruding from the first lower wiring main portion 152LA and extending along the first lower wiring main portion 152LA is integrally formed in one of the first openings 194. In addition, the second lower wiring main portion 152LB is formed in the other of the second openings 195, and the second lower protruding portion 153LB protruding from the second lower wiring main portion 152LB and extending along the second lower wiring main portion 152LB is integrally formed in the other of the first openings 194.

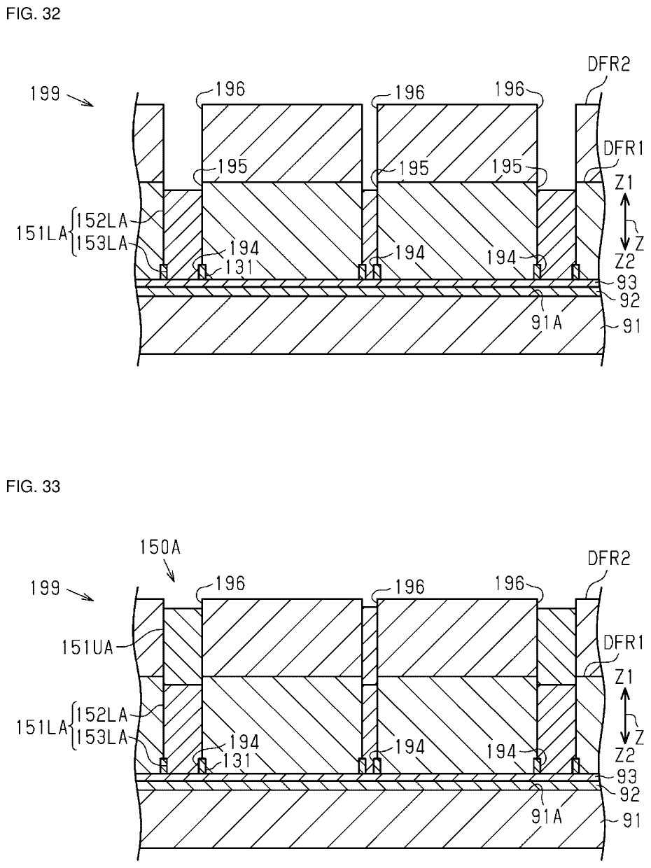

Next, as illustrated in FIG. 32, the second DFR forming step S117 is performed. In the second DFR forming step S117, a second dry film resist DFR2 having two third openings 196 is formed by photolithography on the upper surface of the first dry film resist DFR1. The two third openings 196 has specified patterns. Specifically, the position and shape of one of the third openings 196 correspond to the position and shape of the first upper inductor wiring line 151UA to be formed later. The position and shape of the other of the third openings 196 correspond to the position and shape of the second upper inductor wiring line 151UB to be formed later.

Next, as illustrated in FIG. 33, the upper inductor wiring line forming step S118 is performed. In the upper inductor wiring line forming step S118, the upper inductor wiring lines are formed by electrolytic plating by supplying electric current to the seed layer 93. Specifically, the first upper inductor wiring line 151UA is formed in one of the third openings 196 of the second dry film resist DFR2. In addition, the second upper inductor wiring line 151UB is formed in the other of the third openings 196.

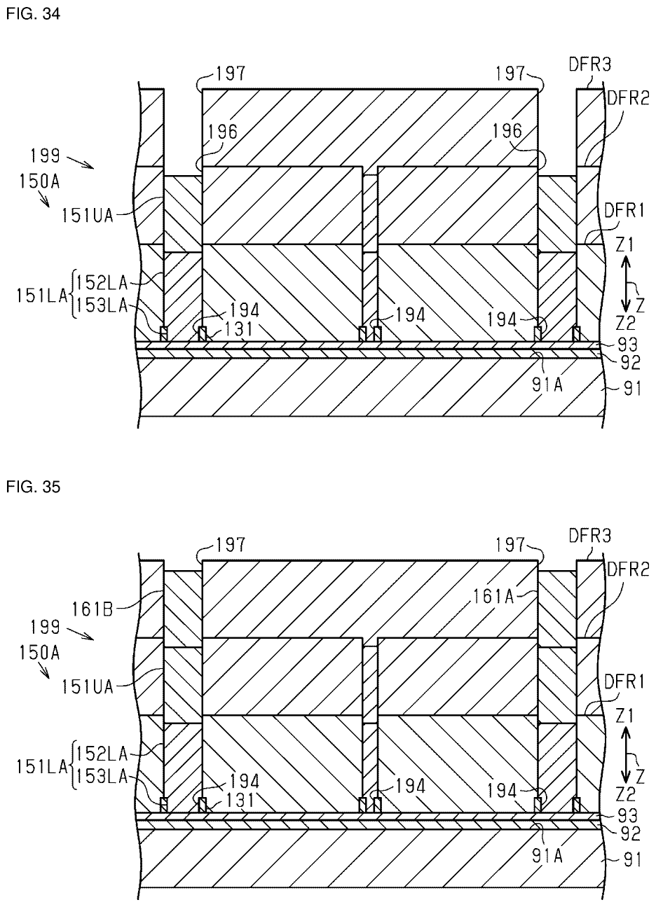

Next, as illustrated in FIG. 34, the third DFR forming step S119 is performed. In the third DFR forming step S119, a third dry film resist DFR3 having four fourth openings 197 is formed by photolithography on the upper surface of each upper inductor wiring line and the upper surface of the second dry film resist DFR2.

Next, as illustrated in FIG. 35, the columnar wiring line forming step S120 is performed. In the columnar wiring line forming step S120, the first to fourth columnar wiring lines 161A to 161D are formed in the four fourth openings 197. The positions and shapes of the first to fourth columnar wiring lines 161A to 161D correspond to the positions and shapes of the four fourth openings 197. With this step, the first inductor wiring line 150A, the second inductor wiring line 150B, and the first to fourth columnar wiring lines 161A to 161D are formed.

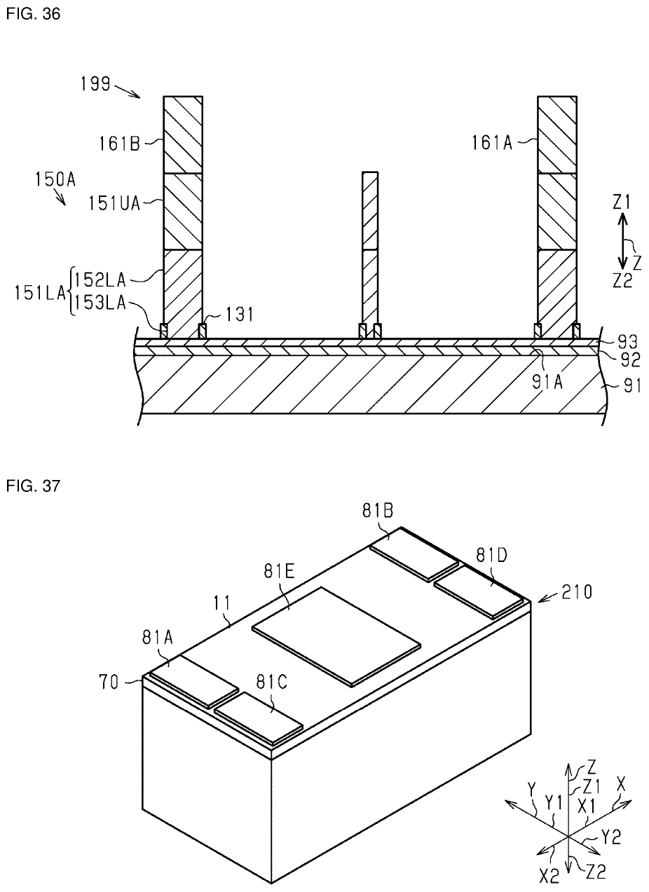

Next, as illustrated in FIG. 36, the DFR removing step S121 is performed. In the DFR removing step S121, all of the first dry film resist DFR1, the second dry film resist DFR2, and the third dry film resist DFR3 are removed by etching.

As illustrated in FIG. 28, after the DFR removing step S121 is performed, the process from the first element body forming step S122 to the singulation step S127 is performed in methods the same as or similar to those of the first embodiment. Through these steps, the inductor component 110 of the second embodiment is manufactured. Note that the structure in the period from the upper inductor wiring line forming step S118 until the base substrate 91 is removed in the seed layer removing step S124 can be treated as a substrate 199 for manufacturing the inductor component.

### Effects of Second Embodiment

The second embodiment described above provides not only the effects of (1-1) to (1-7) and (1-10) to (1-15) described above but also the following effects.
(2-1) In the embodiment described above, the inductor component 110 includes, in addition to the first inductor wiring line 150A, the second inductor wiring line 150B. This reduces the mounting area, compared with a case where two inductor components each including one inductor wiring line are mounted.
(2-2) In the embodiment described above, in a cross-sectional view taken along a cross section orthogonal to the first main surface 11A, there is no large difference between the dimension of each upper pad portion and the dimension of each columnar wiring line in the direction parallel to the first main surface 11A. Thus, compared with a configuration in which the difference between the dimensions mentioned above is large, the DC resistance resulting from such a difference can be reduced.
(2-3) In the embodiment described above, each upper pad portion is in contact with the corresponding columnar wiring line, and the size of the lower surface of each columnar wiring line is smaller than the size of the upper surface of the pad portion to which the columnar wiring line is connected. Thus, even when manufacturing deviations occur between the position of the second dry film resist DFR2 and the position of the third dry film resist DFR3 during the manufacturing process of the inductor component 110, each columnar wiring line can be formed on the upper surface of the corresponding upper pad portion. This makes it possible to ensure a sufficient cross-sectional area for coupling.
(2-4) In the embodiment described above, the maximum width dimension 151UW of the first upper inductor wiring line 151UA is within a range from −20% to +20%, inclusive, relative to the maximum width dimension 152LW of the first lower wiring main portion 152LA. If the ratio is less than −20%, there is a possibility that the DC resistance of the first upper inductor wiring line 151UA increases. If the ratio is greater than 20%, there is a possibility that manufacturing deviations are likely to occur resulting from, for example, difficulty in compacting a magnetic material during the manufacturing of the inductor component 110. However, in this case, since the maximum width dimension 151UW of the first upper inductor wiring line 151UA and the maximum width dimension 152LW of the first lower wiring main portion 152LA are approximately the same, the DC resistance of the first upper inductor wiring line 151UA can be low, and it is also possible to avoid a situation in which compacting a magnetic material between the first lower wiring main portion 152LA and the first upper inductor wiring line 151UA is difficult. In this regard, the same applies to the second inductor wiring line 150B.

### Modifications

The embodiments described above and the following modifications can be combined and implemented within a range in which no technical contradiction occurs. For example, a modification of the first embodiment can be combined with the second embodiment within a range in which no technical contradiction occurs.

### Modifications of First Embodiment

The shape of the element body 11 is not limited to the example of the embodiment described above. The element body 11 may be configured to omit part of the magnetic layer 20 as long as the element body 11 functions as the inductor component 10.

The metal magnetic powder used for the material of the element body 11 is not limited to FeSiCr-based magnetic powder. For example, metal magnetic powders such as FeCo-based, FeSiAr-based, iron oxide-based powders may be used, and combinations of some of them may also be used. The organic resin used for the material of the element body 11 may be epoxy-based, imide-based, liquid crystal polymer-based, acrylic-based, or phenol-based resin, or a combination of some of these, and an inorganic filler may be mixed with these materials. In addition, the material of the element body 11 may be a non-magnetic material.

The material of the second insulating layer 32 may contain a filler in addition to a resin. Containing a filler makes the surface of the second insulating layer 32 irregular. This increases the adhesion between the side surface 53US of the upper protruding portion 53U and the second insulating layer 32. This increases the insulation between different portions of the inductor wiring line 50 in the vicinity of the contact portions between the lower wiring main portion 52L and the upper protruding portion 53U. The coefficient of linear expansion can be adjusted by adjusting the filler content. This increases the degree of freedom in designing the inductor component 10. Note that the first insulating layer 31 and the third insulating layer 33 may also contain a filler.

The configuration of the inductor wiring line 50, including its shape, number, and position, is not limited to the example in the embodiment described above. The configuration can be changed as appropriate depending on the shape of the element body 11 and the use of the inductor component 10.

The inductor wiring line 50 may be exposed on a side surface 11C of the element body 11.

The material of the inductor wiring line 50 is not limited to a conductor containing copper as a main component and may be a conductor containing Ag, Al, or Au as a main component.

The total height dimension 50H of the inductor wiring line 50 may be smaller than twice the minimum width dimension 52LW of the lower wiring main portion 52L. Also in this case, since the lower inductor wiring line 51L includes the lower protruding portion 53L, the cross-sectional area is relatively large, reducing the DC resistance.

The lower protruding portion 53L is not limited to extending from the lower-inner pad portion LP1 continuously to the lower-outer pad portion LP2. For example, the lower protruding portion 53L may extend intermittently in a manner of a dashed dotted line along the inductor wiring line 50. In other words, the lower protruding portion 53L may be partially discontinuous. In this regard, the same applies to the upper protruding portion 53U.

The lower protruding portion 53L and the lower wiring main portion 52L are not limited to ones formed as an integral structure. For example, after the lower protruding portion 53L is formed by electrolytic plating, the electrolytic plating is finished. Thereafter, electrolytic plating is restarted to form the lower wiring main portion 52L. In this case, there is a possibility that an interface is formed between the lower protruding portion 53L and the lower wiring main portion 52L in a strict sense. Also in this case, it can be regarded that, in substance, the lower wiring main portion 52L protrudes from the lower protruding portion 53L. In addition, in the case where the lower protruding portion 53L and the lower wiring main portion 52L are formed as separate portions, the materials of these portions need not necessarily be the same. In this regard, the same applies to the upper protruding portion 53U.

The side surface 53LS of the lower protruding portion 53L is not limited to being in contact with the first insulating layer 31. For example, another metal layer may be interposed between the lower protruding portion 53L and the first insulating layer 31. In this regard, the same applies to the upper protruding portion 53U and the second insulating layer 32.

In the direction orthogonal to the first main surface 11A, the dimension of the lower protruding portion 53L may be smaller than the dimension of the first insulating layer 31. In this case, the distal end of the lower protruding portion 53L does not protrude from the first insulating layer 31 in the third negative direction Z2. Hence, even if manufacturing deviations or the like occur, the distal end of the lower protruding portion 53L is less likely to spread in directions parallel to the first main surface 11A. Thus, it is possible to prevent an unintended short circuit between the distal end of the lower protruding portion 53L and other conductive portions. In this regard, the same applies to the upper protruding portion 53U.

The inductor component 10 is not limited to having the lower resin wall 41 or the upper resin wall 42.

The inductor component 10 is not limited to including the columnar wiring lines. For example, the inductor wiring line 50 may be exposed on a side surface 11C of the element body 11 and connected to outer electrodes.

The first extended portion 63A and the first columnar portion 62A are not limited to being formed as an integral structure. For example, after the first extended portion 63A is formed by electrolytic plating, the electrolytic plating is finished. Thereafter, electrolytic plating is restarted to form the first columnar portion 62A. In this case, there is a possibility that an interface is formed between the first extended portion 63A and the first columnar portion 62A in a strict sense. Also in this case, it can be regarded that, in substance, the first columnar portion 62A protrudes from the first extended portion 63A. In addition, in the case where the first extended portion 63A and the first columnar portion 62A are formed as separate portions, the materials of these portions need not necessarily be the same. In this regard, the same applies the second extended portion 63B and the second columnar portion 62B.

The configuration of each extended portion is not limited to the example of the embodiment described above. For example, the outer edge of the first extended portion 63A need not necessarily be parallel to the outer edge of the first columnar portion 62A. The first extended portion 63A is not limited to being in contact with the surface parallel to the first main surface 11A among the outer surfaces of the upper-inner pad portion UP1 which is an end portion of the inductor wiring line 50. The outer edge of the first extended portion 63A is not limited to being parallel to the outer edge of the upper-inner pad portion UP1. In this regard, the same applies to the second extended portion 63B and the upper-outer pad portion UP2.

In a transparent view in the third positive direction Z1, the area of the region surrounded by the outer edge of the first columnar portion 62A may be larger than 1.3 times the area of the region surrounded by the outer edge of the first extended portion 63A. Even in this case, since the first columnar wiring line 61A includes the first extended portion 63A, at least the effect explained in (1-1) can be achieved. In this regard, the same applies to the second extended portion 63B.

The side surface 63AS of the first extended portion 63A is not limited to being in contact with the third insulating layer 33. For example, another member may be interposed between the first extended portion 63A and the third insulating layer 33. In this regard, the same applies to the second extended portion 63B.

As illustrated in FIG. 23, as long as the inductor component 10 includes the second insulating layer 32, the inductor component 10 need not necessarily include the first insulating layer 31. The inductor component 10 may include a third insulating layer 33 that covers the surfaces of the inductor wiring line 50 and the lower resin wall 41 on the third negative direction Z2 side.

The inductor component 10 is not limited to including each outer electrode and the solder resist 70. For example, each columnar wiring line may be exposed on the first main surface 11A. This reduces the size of the inductor component 10.

In the method of manufacturing the inductor component 10, the order of the steps may be changed as long as the inductor component 10 can be manufactured. For example, the solder resist forming step S24 may be performed after the second element body forming step S26.

The material of the seed layer 93 is not limited to the example of the embodiment described above. For example, the seed layer 93 may be a single layer of copper or silver or may include two or more layers containing titanium, copper, and the like.

The material of the seed layer 93 and the material of the lower protruding portion 53L may be different. For example, the material of the seed layer 93 may be silver, and the material of the inductor wiring line 50 including the lower protruding portion 53L may be copper. This increases the etching rate when the inductor wiring line 50 is separated from the seed layer 93 by etching. In this regard, the same applies to the substrate 99 for manufacturing the inductor component.

In the process from the adhesive layer forming step S12 to the solder resist forming step S24, the inductor wiring line 50 and the like may be formed on each side of the base substrate 91. In this process, when the inductor wiring line 50 and like is formed on the surface of the base substrate 91 on the third negative direction Z2 side, each step is performed with the third negative direction Z2 regarded as the upward direction.

The adhesive layer forming step S12 may be omitted. The seed layer 93 may be formed directly on the upper surface of the base substrate 91. In other words, the substrate 99 for manufacturing the inductor component need not necessarily include the adhesive layer 92.

In the first insulating layer forming step S14, a negative-type photosensitive resin may be used as the material of the first insulating layer 31. In this case, the degree of photocuring of the portion of the first insulating layer 31 to be removed in the insulating layer cutting step S22 may be reduced so that the portion mentioned above can be easily stripped off in the insulating layer cutting step S22.

Depending on the configuration of the inductor component 10 to be manufactured, one or more steps selected from the second insulating layer forming step S17, the columnar wiring line forming step S21, the solder resist forming step S24, the second element body forming step S26, and the outer electrode forming step S27 may be omitted.

The columnar wiring line forming step S21 may be performed without the third insulating layer forming step S20. In this case, supplemental walls may be formed on the outer surface of the upper inductor wiring line 51U on the third positive direction Z1 side in the columnar wiring line forming step S21 to form each columnar wiring line.

In the insulating layer cutting step S22, the method of removing part of the first insulating layer 31 is not limited to methods using laser. For example, part of the first insulating layer 31 may be removed by sandblasting. In this case, the third insulating layer 33 is preferably thicker than the first insulating layer 31. Alternatively, the sandblasting resistance of the third insulating layer 33 is preferably higher than the sandblasting resistance of the first insulating layer 31.

In the case where the second element body forming step S26 is omitted, for example, a layer having insulation may be formed on the lower surfaces of the lower protruding portion 53L, the first insulating layer 31, and the magnetic layer 20 formed in the first element body forming step S23.

In the outer electrode forming step S27, the method of forming each outer electrode is not limited to the example of the embodiment described above. For example, the copper plating need not necessarily be performed.

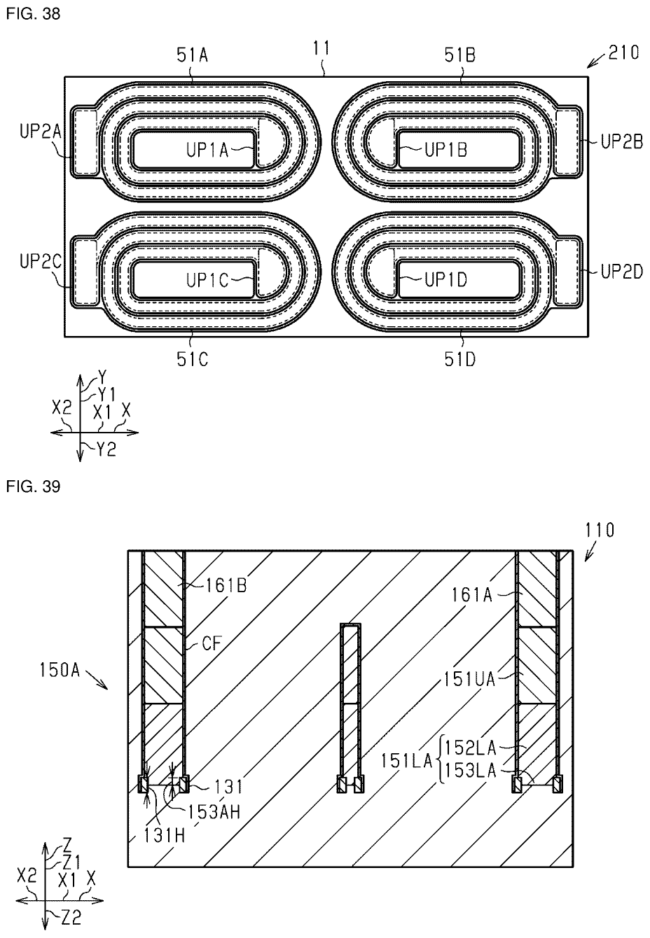

An inductor component 210 according to an example of a combination of modifications will be described with reference to FIGS. 37 and 38.

As illustrated in FIG. 37, the inductor component 210 in one example of a modification includes five outer electrodes. Specifically, the inductor component 210 includes a first outer electrode 81A on the first negative direction X2 side and on the second positive direction Y1 side on the first main surface 11A of the element body 11. The inductor component 210 includes a second outer electrode 81B on the first positive direction X1 side and on the second positive direction Y1 side on the first main surface 11A. The inductor component 210 includes a third outer electrode 81C on the first negative direction X2 side and on the second negative direction Y2 side on the first main surface 11A. The inductor component 210 includes a fourth outer electrode 81D on the first positive direction X1 side and on the second negative direction Y2 side on the first main surface 11A. The inductor component 210 includes a fifth outer electrode 81E located to include an approximate geometric center of the first main surface 11A.

As illustrated in FIG. 38, the inductor component 210 in the example of the modification includes four inductor wiring lines 50. Specifically, the inductor component 210 includes a first inductor wiring line 51A on the first negative direction X2 side and on the second positive direction Y1 side in the element body 11. The inductor component 210 includes a second inductor wiring line 51B on the first positive direction X1 side and on the second positive direction Y1 side in the element body 11. The inductor component 210 includes a third inductor wiring line 51C on the first negative direction X2 side and on the second negative direction Y2 side in the element body 11. The inductor component 210 includes a fourth inductor wiring line 51D on the first positive direction X1 side and on the second negative direction Y2 side in the element body 11.

In the example of this modification, specifically, an upper-outer pad portion UP2A of the first inductor wiring line 51A is connected to the first outer electrode 81A. An upper-outer pad portion UP2B of the second inductor wiring line 51B is connected to the second outer electrode 81B. An upper-outer pad portion UP2C of the third inductor wiring line 51C is connected to the third outer electrode 81C. An upper-outer pad portion UP2D of the fourth inductor wiring line 51D is connected to the fourth outer electrode 81D. Then, an upper-inner pad portion UP1A of the first inductor wiring line 51A, an upper-inner pad portion UP1B of the second inductor wiring line 51B, an upper-inner pad portion UP1C of the third inductor wiring line 51C, and an upper-inner pad portion UP1D of the fourth inductor wiring line 51D are connected to the fifth outer electrode 81E. Hence, the fifth outer electrode 81E, which is one of the plurality of outer electrodes, is connected to both a first end of the first inductor wiring line 51A and a first end of the second inductor wiring line 51B. Thus, there is no potential difference between the outer electrodes to which the inductor wiring lines are connected. An electronic component having such a configuration is suitable, for example, as an inductor used in a multi-phase DC/DC converter.

### Modification of Second Embodiment

As illustrated in FIG. 39, in the direction orthogonal to the first main surface 11A, the dimension 153AH of the first lower protruding portion 153LA may be smaller than the dimension 131H of the first insulating layer 131. In this case, the distal end of the first lower protruding portion 153LA does not protrude from the first insulating layer 131 in the third negative direction Z2. Hence, even if manufacturing deviations or the like occur, the distal end of the first lower protruding portion 153LA is less likely to spread in directions parallel to the first main surface 11A. Thus, it is possible to prevent an unintended short circuit between the distal end of the first lower protruding portion 153LA and other conductive portions. In this regard, the same applies to the second lower protruding portion 153LB.

As illustrated in FIG. 39, the inductor component 110 may include insulation coating CF that covers the side surface of the first lower wiring main portion 152LA, the side surface of the first upper inductor wiring line 151UA, the side surface of the first insulating layer 131, the side surface of the first columnar wiring line 161A, and the side surface of the second columnar wiring line 161B. This increases the insulation between the inductor wiring lines and between the columnar wiring lines. In this regard, the same applies to the second inductor wiring line 150B.

The maximum width dimension 151UW of the first upper inductor wiring line 151UA may be less than −20% or greater than +20% relative to the maximum width dimension 152LW of the first lower wiring main portion 152LA. Even in this case, at least the effect explained in (1-1) can be achieved.

As illustrated in FIG. 39, the inductor component 110 need not necessarily include the outer electrodes and the solder resist 70. In this case, for example, each columnar wiring line may be exposed on the first main surface 11A. This reduces the size of the inductor component 110. In the case of this example, the surfaces of the columnar wiring lines on the third positive direction Z1 side function as outer electrodes.

The first DFR forming step S115 and the second DFR forming step S117 may be performed in a single step.

The electrical conductivity at the outer surface of the first lower protruding portion 153LA on the third negative direction Z2 side may be lower than the electrical conductivity of the first lower wiring main portion 152LA or the first upper inductor wiring line 151UA. For example, the distal end of the first lower protruding portion 153LA may be oxidized by heat treatment to reduce its electrical conductivity. This increases the insulation between the first inductor wiring line 150A and the element body 11. In this regard, the same applies to the second lower protruding portion 153LB and the second inductor wiring line 150B.

The size of the end surface of each columnar wiring line on the third negative direction Z2 side may be smaller than the size of the surface on the third positive direction Z1 side of the pad portion to which the columnar wiring line is connected. In this case, in a cross-sectional view taken along a cross section orthogonal to the first main surface 11A, in the direction parallel to the first main surface 11A, the difference between the dimension UP1AW of the first-end upper pad portion UP1A of the first upper pad portions UPA and the dimension 161AW of the first columnar wiring line 161A is preferably 20 μm or less. Similarly, in cross-sectional view taken along a cross section orthogonal to the first main surface 11A, in the direction parallel to the first main surface 11A, the difference between the dimension UP2AW of the second-end upper pad portion UP2A of the second upper pad portions UPB and the dimension 161BW of the second columnar wiring line 161B is preferably 20 μm or less.

Thus, even when slight manufacturing deviations occur between the position of the first dry film resist DFR1 and the position of the second dry film resist DFR2 during the manufacturing process of the inductor component 110, each columnar wiring line can be within the region of the corresponding pad portion.

However, even if the difference is greater than 20 μm, since each wiring main portion includes a protruding portion, at least the effect explained in (1-1) can be achieved. In this regard, the same applies to the second upper pad portions UPB.

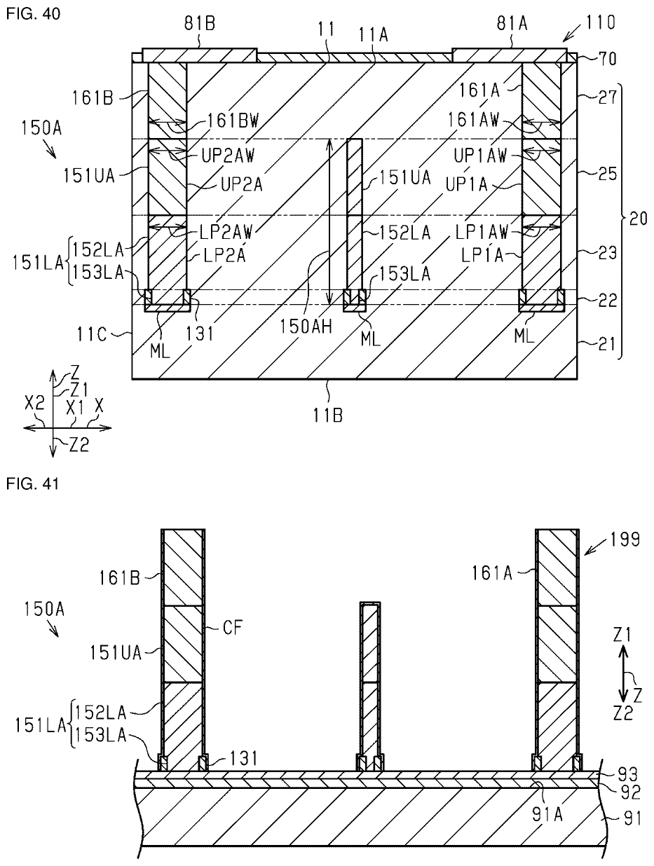

The outer surface of the first lower protruding portion 153LA on the third negative direction Z2 side need not necessarily be in contact with the element body 11. For example, as illustrated in FIG. 40, the inductor component 110 may include a metal layer ML that covers the outer surface of the first lower protruding portion 153LA on the third negative direction Z2 side. In this case, in a transparent view in the third positive direction Z1, the metal layer ML preferably extends along the first lower protruding portion 153LA. For example, when nickel is selected as the material of the metal layer ML, it is possible to suppress oxidation of the outer surface of the first lower protruding portion 153LA on the third negative direction Z2 side and deterioration of the outer surface of the first insulating layer 131 on the third negative direction Z2 side. The metal layer ML may be formed by removing the base substrate 91 and performing etching such that the seed layer 93 covers the first lower protruding portion 153LA, instead of performing the seed layer removing step S124. In addition, the electrical conductivity of the metal layer ML is preferably lower than the electrical conductivity of the first inductor wiring line 150A. This increases the insulation between the first inductor wiring line 150A and the element body 11. In this regard, the same applies to the second inductor wiring line 150B and the second lower protruding portion 153LB.

As illustrated in FIG. 41, a step of covering the side surface of each inductor wiring line and the side surface of each columnar wiring line with insulation coating CF may be performed after the DFR removing step S121 and before the first element body forming step S122. Films of the insulation coating CF may be formed, for example, by chemical vapor deposition (CVD). This increases the insulation between the inductor wiring lines and between the columnar wiring lines.

### Appendices

The following describes technical ideas derivable from the embodiments and modifications described above.
[1] An inductor component including an element body containing a magnetic material and having a planar main surface; an insulating layer located in the element body and extending along a plane parallel to the main surface; a lower inductor wiring line extending parallel to the main surface in the element body; and an upper inductor wiring line extending parallel to the main surface in the element body. When one direction orthogonal to the main surface is defined as a positive direction, and the direction opposite to the positive direction is defined as a negative direction. The lower inductor wiring line includes a lower wiring main portion extending on an outer surface of the insulating layer on the positive direction side, and a protruding portion protruding in the negative direction from an outer surface of the lower wiring main portion on the negative direction side. The outer surface of the lower wiring main portion on the negative direction side is in contact with the outer surface of the insulating layer on the positive direction side. In a transparent view in the positive direction, the protruding portion is located within a region surrounded by an outer edge of the lower wiring main portion and extends along the lower wiring main portion. In a cross-sectional view taken along a cross section orthogonal to the main surface, the dimension of the protruding portion in the direction parallel to the main surface is smaller than the dimension of the lower wiring main portion in the direction parallel to the main surface at the position where the protruding portion is connected in the same cross section. The upper inductor wiring line extends along the lower wiring main portion on an outer surface of the lower wiring main portion on the positive direction side, and an outer surface of the upper inductor wiring line on the negative direction side is in contact with a surface of the lower inductor wiring line on the positive direction side.
[2] The inductor component according to [1], in which when the sum of the maximum dimension of the lower inductor wiring line and the maximum dimension of the upper inductor wiring line in the direction orthogonal to the main surface is defined as the total height dimension, and the minimum dimension of the lower wiring main portion in the direction orthogonal to the center line of the lower wiring main portion and parallel to the main surface is defined as the minimum width dimension. Also, the total height dimension is at least twice the minimum width dimension.
[3] The inductor component according to [1] or [2], in which when the maximum dimension of the lower wiring main portion in the direction orthogonal to the center line of the lower inductor wiring line and parallel to the main surface is defined as the maximum width dimension of the lower wiring main portion. The maximum dimension of the upper inductor wiring line in the direction orthogonal to the center line of the upper inductor wiring line and parallel to the main surface is defined as the maximum width dimension of the upper inductor wiring line, and the maximum width dimension of the upper inductor wiring line is within a range from −20% to +20%, inclusive, relative to the maximum width dimension of the lower wiring main portion.
[4] The inductor component according to any one of [1] to [3], in which the lower wiring main portion and the protruding portion are formed as an integral structure.
[5] The inductor component according to any one of [1] to [4], in which when the outer surfaces of the element body other than the main surface and a surface opposite to the main surface are defined as the side surface of the element body, the lower inductor wiring line and a conductive member electrically connected to the lower inductor wiring line, and the upper inductor wiring line and a conductive member electrically connected to the upper inductor wiring line, are not exposed on the side surface of the element body.
[6] The inductor component according to any one of [1] to [5], in which when the outer surfaces of the protruding portion other than an outer surface of the protruding portion on the negative direction side is defined as the side surface of the protruding portion, the side surface of the protruding portion is in contact with the insulating layer.
[7] The inductor component according to [6], in which in the direction orthogonal to the main surface, the dimension of the protruding portion is smaller than the dimension of the insulating layer.
[8] The inductor component according to any one of [1] to [7], further including a columnar wiring line connected to an outer surface of the upper inductor wiring line on the positive direction side and extending in a direction intersecting the main surface in the element body.
[9] The inductor component according to [8], in which the columnar wiring line is in contact with the outer surface of the upper inductor wiring line on the positive direction side.
[10] The inductor component according to [8] or [9], in which when the outer surfaces of the lower wiring main portion other than the outer surface of the lower wiring main portion on the positive direction side and the outer surface of the lower wiring main portion on the negative direction side are defined as the side surface of the lower wiring main portion, the outer surfaces of the upper inductor wiring line other than the outer surface of the upper inductor wiring line on the positive direction side and the outer surface of the upper inductor wiring line on the negative direction side are defined as the side surface of the upper inductor wiring line. Also, the outer surfaces of the columnar wiring line other than an outer surface of the columnar wiring line on the positive direction side and an outer surface of the columnar wiring line on the negative direction side are defined as the side surface of the columnar wiring line. In addition, the outer surfaces of the insulating layer other than the outer surface of the insulating layer on the positive direction side and an outer surface of the insulating layer on the negative direction side are defined as the side surface of the insulating layer, and the inductor component further includes insulation coating that covers the side surface of the lower wiring main portion, the side surface of the upper inductor wiring line, the side surface of the columnar wiring line, and the side surface of the insulating layer.
[11] The inductor component according to any one of [1] to [10], in which when the insulating layer is regarded as a first insulating layer, and the protruding portion is regarded as a lower protruding portion, and the inductor component further includes a second insulating layer located in the element body and parallel to the main surface. The upper inductor wiring line includes an upper wiring main portion extending on an outer surface of the second insulating layer on the positive direction side, and an upper protruding portion protruding in the negative direction from an outer surface of the upper wiring main portion on the negative direction side. In a transparent view in the positive direction, the upper protruding portion is located within a region surrounded by an outer edge of the upper wiring main portion and extends along the upper wiring main portion. The outer surface of the upper wiring main portion on the negative direction side is in contact with the outer surface of the second insulating layer on the positive direction side. In a cross-sectional view taken along a cross section orthogonal to the main surface, the dimension of the upper protruding portion in the direction parallel to the main surface is smaller than the dimension of the upper wiring main portion in the direction parallel to the main surface at the position where the upper protruding portion is connected in the same cross section, and a surface of the upper protruding portion on the negative direction side is in contact with the outer surface of the lower wiring main portion on the positive direction side.
[12] The inductor component according to [11], in which the upper wiring main portion and the upper protruding portion are formed as an integral structure.
[13] The inductor component according to [11] or [12], in which the material of the second insulating layer contains a resin and a filler composed of a powder of a crystalline material.
[14] The inductor component according to any one of [11] to [13], in which when the outer surfaces of the lower wiring main portion other than the outer surface of the lower wiring main portion on the positive direction side and the outer surface of the lower wiring main portion on the negative direction side are defined as the side surface of the lower wiring main portion. Also, the outer surfaces of the second insulating layer other than the outer surface of the second insulating layer on the positive direction side and an outer surface of the second insulating layer on the negative direction side are defined as the side surface of the second insulating layer, the inductor component further includes a lower resin wall that covers the side surface of the lower wiring main portion, and the lower resin wall is in contact with the side surface of the second insulating layer.
[15] A method of manufacturing an inductor component, including a seed layer forming step of forming a seed layer having conductivity on a main surface of a base substrate; an insulating layer forming step of forming an insulating layer on the seed layer, the insulating layer having an opening corresponding to a specified wiring pattern; a lower resin wall forming step of forming a lower resin wall along an outer edge of the opening on the insulating layer; and a lower inductor wiring line forming step of forming a lower wiring main portion in a space surrounded by the lower resin wall by electrolytic plating by supplying electric current to the seed layer, and forming a lower protruding portion in the opening, the lower protruding portion protruding from the lower wiring main portion and extending along the lower wiring main portion. The method further includes an upper resin wall forming step of forming an upper resin wall along an outer edge of the lower wiring main portion on an upper side of the lower wiring main portion; an upper inductor wiring line forming step of forming an upper inductor wiring line in a space surrounded by the upper resin wall by electrolytic plating by supplying electric current to the seed layer; an element body forming step of forming a magnetic layer containing a magnetic material around the lower wiring main portion, the lower protruding portion, and the upper inductor wiring line after the upper inductor wiring line forming step; and a seed layer removing step of removing the seed layer after the element body forming step.
[16] The method of manufacturing an inductor component according to [15], in which when the insulating layer forming step is regarded as a first insulating layer forming step, the opening is regarded as a first opening, and the insulating layer is regarded as a first insulating layer, the method includes a second insulating layer forming step of forming a second insulating layer on the lower wiring main portion, the second insulating layer having a second opening extending along the lower wiring main portion, after the lower inductor wiring line forming step and before the upper resin wall forming step; and the upper resin wall forming step of forming the upper resin wall along an outer edge of the second opening of the second insulating layer on the upper side of the lower wiring main portion. Also, the upper inductor wiring line forming step of forming an upper wiring main portion in a space surrounded by the upper resin wall by electrolytic plating by supplying electric current to the seed layer, and forming an upper protruding portion in the second opening, the upper protruding portion protruding from the upper wiring main portion and extending along the upper wiring main portion; and the element body forming step of forming the magnetic layer containing a magnetic material around the lower wiring main portion, the lower protruding portion, the upper wiring main portion, and the upper protruding portion.
[17l ] A substrate for manufacturing an inductor component, including a base substrate; a seed layer located on a main surface side of the base substrate and having conductivity; an insulating layer located on the seed layer and extending parallel to the main surface of the base substrate; a lower inductor wiring line located on the insulating layer and extending parallel to the main surface of the base substrate; and an upper inductor wiring line located on the lower inductor wiring line and extending parallel to the main surface of the base substrate. When one direction orthogonal to the main surface of the base substrate is defined as a positive direction, and the direction opposite to the positive direction is defined as a negative direction, the lower inductor wiring line includes a lower wiring main portion extending on an outer surface of the insulating layer on the positive direction side, and a protruding portion protruding in the negative direction from an outer surface of the lower wiring main portion on the negative direction side. In a transparent view in the positive direction, the protruding portion extends along the lower wiring main portion, a surface of the protruding portion on the negative direction side is in contact with the seed layer, the upper inductor wiring line extends along the lower wiring main portion on an outer surface of the lower wiring main portion on the positive direction side, and a surface of the upper inductor wiring line on the negative direction side is in contact with a surface of the lower inductor wiring line on the positive direction side.
[18] The substrate for manufacturing an inductor component according to [17], in which the material of the seed layer and the material of the protruding portion are different.
[19] The substrate for manufacturing an inductor component according to [17] or [18] , further including an adhesive layer interposed between the base substrate and the seed layer, in which the material of the adhesive layer is a resin having adhesiveness.

What is claimed is:

1. An inductor component comprising:
an element body including a magnetic material and having a planar main surface;
an insulating layer in the element body and extending along a plane parallel to the main surface;
a lower inductor wiring line extending parallel to the main surface in the element body; and
an upper inductor wiring line extending parallel to the main surface in the element body, wherein
when one direction orthogonal to the main surface is defined as a positive direction, and the direction opposite to the positive direction is defined as a negative direction,
the lower inductor wiring line includes
a lower wiring main portion extending on an outer surface of the insulating layer on the positive direction side, and
a protruding portion protruding in the negative direction from an outer surface of the lower wiring main portion on the negative direction side,
the outer surface of the lower wiring main portion on the negative direction side is in contact with the outer surface of the insulating layer on the positive direction side,
in a transparent view when viewed in the positive direction, the protruding portion is within a region surrounded by an outer edge of the lower wiring main portion and extends along the lower wiring main portion,
in a cross-sectional view taken along a cross section orthogonal to the main surface, a dimension of the protruding portion in the direction parallel to the main surface is smaller than a dimension of the lower wiring main portion in the direction parallel to the main surface at the position where the protruding portion is connected to the lower wiring main portion in the same cross section,
the upper inductor wiring line extends along the lower wiring main portion on an outer surface of the lower wiring main portion on the positive direction side, and
an outer surface of the upper inductor wiring line on the negative direction side is in contact with a surface of the lower inductor wiring line on the positive direction side.

2. The inductor component according to claim 1, wherein
when a sum of a maximum dimension of the lower inductor wiring line and a maximum dimension of the upper inductor wiring line in the direction orthogonal to the main surface is defined as a total height dimension, and
a minimum dimension of the lower wiring main portion in the direction orthogonal to a center line of the lower wiring main portion and parallel to the main surface is defined as a minimum width dimension,
the total height dimension is at least twice the minimum width dimension.

3. The inductor component according to claim 1, wherein
when a maximum dimension of the lower wiring main portion in the direction orthogonal to a center line of the lower inductor wiring line and parallel to the main surface is defined as a maximum width dimension of the lower wiring main portion, and
a maximum dimension of the upper inductor wiring line in the direction orthogonal to a center line of the upper inductor wiring line and parallel to the main surface is defined as a maximum width dimension of the upper inductor wiring line,
the maximum width dimension of the upper inductor wiring line is within a range from −20% to +20% relative to the maximum width dimension of the lower wiring main portion.

4. The inductor component according to claim 1, wherein
the lower wiring main portion and the protruding portion are formed as an integral structure.

5. The inductor component according to claim 1, wherein
when the outer surfaces of the element body other than the main surface and a surface opposite to the main surface are defined as a side surface of the element body,
the lower inductor wiring line and a conductive member electrically connected to the lower inductor wiring line, and the upper inductor wiring line and a conductive member electrically connected to the upper inductor wiring line, are not exposed on the side surface of the element body.

6. The inductor component according to claim 1, wherein
when the outer surfaces of the protruding portion other than an outer surface of the protruding portion on the negative direction side is defined as a side surface of the protruding portion,
the side surface of the protruding portion is in contact with the insulating layer.

7. The inductor component according to claim 6, wherein
in the direction orthogonal to the main surface, the dimension of the protruding portion is smaller than the dimension of the insulating layer.

8. The inductor component according to claim 1, further comprising:
a columnar wiring line connected to an outer surface of the upper inductor wiring line on the positive direction side and extending in a direction intersecting the main surface in the element body.

9. The inductor component according to claim 8, wherein
the columnar wiring line is in contact with the outer surface of the upper inductor wiring line on the positive direction side.

10. The inductor component according to claim 8, wherein
when the outer surfaces of the lower wiring main portion other than the outer surface of the lower wiring main portion on the positive direction side and the outer surface of the lower wiring main portion on the negative direction side are defined as a side surface of the lower wiring main portion,
the outer surfaces of the upper inductor wiring line other than the outer surface of the upper inductor wiring line on the positive direction side and the outer surface of the upper inductor wiring line on the negative direction side are defined as a side surface of the upper inductor wiring line,
the outer surfaces of the columnar wiring line other than an outer surface of the columnar wiring line on the positive direction side and an outer surface of the columnar wiring line on the negative direction side are defined as a side surface of the columnar wiring line, and
the outer surfaces of the insulating layer other than the outer surface of the insulating layer on the positive direction side and an outer surface of the insulating layer on the negative direction side are defined as a side surface of the insulating layer,
the inductor component further comprises insulation coating that covers the side surface of the lower wiring main portion, the side surface of the upper inductor wiring line, the side surface of the columnar wiring line, and the side surface of the insulating layer.

11. The inductor component according to claim 1, wherein
when the insulating layer is regarded as a first insulating layer, and the protruding portion is regarded as a lower protruding portion,
the inductor component further comprises a second insulating layer in the element body and parallel to the main surface,
the upper inductor wiring line includes
an upper wiring main portion extending on an outer surface of the second insulating layer on the positive direction side, and
an upper protruding portion protruding in the negative direction from an outer surface of the upper wiring main portion on the negative direction side,
in a transparent view in the positive direction, the upper protruding portion is within a region surrounded by an outer edge of the upper wiring main portion and extends along the upper wiring main portion,
the outer surface of the upper wiring main portion on the negative direction side is in contact with the outer surface of the second insulating layer on the positive direction side,
in a cross-sectional view taken along a cross section orthogonal to the main surface, the dimension of the upper protruding portion in the direction parallel to the main surface is smaller than the dimension of the upper wiring main portion in the direction parallel to the main surface at the position where the upper protruding portion is connected in the same cross section, and
a surface of the upper protruding portion on the negative direction side is in contact with the outer surface of the lower wiring main portion on the positive direction side.

12. The inductor component according to claim 11, wherein
the upper wiring main portion and the upper protruding portion are an integral structure.

13. The inductor component according to claim 11, wherein
a material of the second insulating layer includes a resin and a filler including a powder of a crystalline material.

14. The inductor component according to claim 11, wherein
when the outer surfaces of the lower wiring main portion other than the outer surface of the lower wiring main portion on the positive direction side and the outer surface of the lower wiring main portion on the negative direction side are defined as the side surface of the lower wiring main portion, and
the outer surfaces of the second insulating layer other than the outer surface of the second insulating layer on the positive direction side and an outer surface of the second insulating layer on the negative direction side are defined as the side surface of the second insulating layer,
the inductor component further comprises a lower resin wall that covers the side surface of the lower wiring main portion, and
the lower resin wall is in contact with the side surface of the second insulating layer.

15. The inductor component according to claim 2, wherein
when a maximum dimension of the lower wiring main portion in the direction orthogonal to a center line of the lower inductor wiring line and parallel to the main surface is defined as a maximum width dimension of the lower wiring main portion, and
a maximum dimension of the upper inductor wiring line in the direction orthogonal to a center line of the upper inductor wiring line and parallel to the main surface is defined as a maximum width dimension of the upper inductor wiring line,
the maximum width dimension of the upper inductor wiring line is within a range from −20% to +20% relative to the maximum width dimension of the lower wiring main portion.

16. A method of manufacturing an inductor component, comprising:
forming a seed layer having conductivity on a main surface of a base substrate;
forming an insulating layer on the seed layer, the insulating layer having an opening corresponding to a specified wiring pattern;
forming a lower resin wall along an outer edge of the opening on the insulating layer;
forming a lower wiring main portion in a space surrounded by the lower resin wall by electrolytic plating by supplying electric current to the seed layer, and forming a lower protruding portion in the opening, the lower protruding portion protruding from the lower wiring main portion and extending along the lower wiring main portion;
forming an upper resin wall along an outer edge of the lower wiring main portion on an upper side of the lower wiring main portion;
forming an upper inductor wiring line in a space surrounded by the upper resin wall by electrolytic plating by supplying electric current to the seed layer;
forming a magnetic layer including a magnetic material around the lower wiring main portion, the lower protruding portion, and the upper inductor wiring line after the forming an upper inductor wiring line;
forming an element body; and
removing the seed layer after the forming an element body.

17. The method of manufacturing an inductor component according to claim 16, wherein
when the forming an insulating layer is a first insulating layer forming operation, the opening is a first opening, and the insulating layer is a first insulating layer,
the method comprises:
forming a second insulating layer on the lower wiring main portion, the second insulating layer having a second opening extending along the lower wiring main portion, after the forming a lower inductor wiring line and before the forming an upper resin wall;
the forming an upper resin wall includes forming the upper resin wall along an outer edge of the second opening of the second insulating layer on the upper side of the lower wiring main portion;
the forming an upper inductor wiring line includes forming an upper wiring main portion in a space surrounded by the upper resin wall by electrolytic plating by supplying electric current to the seed layer, and forming an upper protruding portion in the second opening, the upper protruding portion protruding from the upper wiring main portion and extending along the upper wiring main portion; and
the forming an element body includes forming the magnetic layer including a magnetic material around the lower wiring main portion, the lower protruding portion, the upper wiring main portion, and the upper protruding portion.

18. A substrate for manufacturing an inductor component, comprising:
a base substrate;
a seed layer on a main surface side of the base substrate and having conductivity;
an insulating layer on the seed layer and extending parallel to the main surface of the base substrate;
a lower inductor wiring line on the insulating layer and extending parallel to the main surface of the base substrate; and
an upper inductor wiring line on the lower inductor wiring line and extending parallel to the main surface of the base substrate, wherein
when one direction orthogonal to the main surface of the base substrate is defined as a positive direction, and the direction opposite to the positive direction is defined as a negative direction,
the lower inductor wiring line includes
a lower wiring main portion extending on an outer surface of the insulating layer on the positive direction side, and
a protruding portion protruding in the negative direction from an outer surface of the lower wiring main portion on the negative direction side,
in a transparent view in the positive direction, the protruding portion extends along the lower wiring main portion,
a surface of the protruding portion on the negative direction side is in contact with the seed layer,
the upper inductor wiring line extends along the lower wiring main portion on an outer surface of the lower wiring main portion on the positive direction side, and
a surface of the upper inductor wiring line on the negative direction side is in contact with a surface of the lower inductor wiring line on the positive direction side.

19. The substrate for manufacturing an inductor component according to claim 18, wherein
a material of the seed layer and a material of the protruding portion are different.

20. The substrate for manufacturing an inductor component according to claim 18, further comprising:
an adhesive layer interposed between the base substrate and the seed layer, wherein
a material of the adhesive layer is a resin having adhesiveness.
